(19) United States
(12) Patent Application Publication
(10) Pub. No.: US 2010/0215092 A1
(43) Pub. Date: Aug. 26, 2010

(54) Method and Apparatus for Multiple Description Coding

(75) Inventors: Marcin Kuropatwinski, Gdansk-Wrzeszcz (PL); Janusz Klejsa, Stockholm (SE); Willem Bastiaan Kleijn, Stocksund (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/681,447

(22) PCT Filed: Mar. 28, 2008
(86) PCT No.: PCT/SE08/50355

§ 371 Date: Apr. 2, 2010

Related U.S. Application Data
(60) Provisional application No. 60/977,799, filed on Oct. 5, 2007.

(51) Int. Cl. H04B 1/66; H04L 25/03

(52) U.S. Cl. 375/240; 375/296

(57) ABSTRACT

The present invention relates to a method and apparatus to be used in designing an index assignment matrix for use in multiple description coding of an information signal. The bandwidth of the index assignment matrix is selected in dependence of transmission condition information relating to a transmission condition of a communication channel onto which a description of the information signal can be transmitted.

### TECHNICAL FIELD

The present invention relates to the field of multiple description coding in a communications system, and in particular to the design of an index assignment matrix to be used for multiple description coding.

### BACKGROUND

In any communications system, there is a risk that information that is transmitted from a transmitting end to a receiving end will be lost during transmission. In order to compensate for such loss, diversity is often introduced, so that the information is transmitted over two or more independent channels. Such independent channels can for example be achieved by employing two or more different transmission paths and/or by transmitting the information at two or more different points in time or at different frequencies.

By employing diversity to a communications interface, the amount of redundant information transmitted over the interface will generally increase. Since transmission bandwidth is often a scarce resource on a communications interface, there is a general desire to keep the redundancy of transmitted information as low as possible. A technique referred to as multiple description coding (MDC) has been developed in order to address this, whereby an information source is encoded into two or more different descriptions in a manner so that an estimate of the source can be obtained from any subset of the descriptions. The different descriptions are then transmitted over the different channels of the communications interface employing diversity. In a scenario where the probability of packet erasure is large, the different descriptions can be chosen to be similar to each other so that redundancy is large, whereas in a scenario where the probability of packet erasure is small, the different descriptions can be chosen to differ from each other to a greater extent, so that redundancy is smaller.

The problem of how to design an encoder operating according to MDC has been addressed in a number of publications. In V. A. Vaishampayan, “Design of multiple description scalar quantizers”, IEEE Transactions on Information Theory, vol. 39, pp. 821-834, May 1993, an iterative method of designing an MDC encoder is disclosed, wherein the method is based on a generalisation of Lloyd's algorithm. A central quantizer is designed, and the cells of the central quantizer are mapped onto two different side coder cells. In this paper, two different algorithms are described for filling an index assignment matrix by mapping the central quantizer cells onto the cells of different side coders. These different algorithms are referred to as the linear index assignment algorithm and the nested index assignment algorithm.

The method described by Vaishampayan of designing an MDC encoder involves optimisation of an index assignment matrix by way of iteration. Such iterative optimisation of the MDC encoder requires high processing power. A way of designing a feasible index assignment matrix that requires less processing power is desired.

### SUMMARY

A problem to which the present invention relates is the problem of how to reduce the processing power required for the design of an index assignment matrix.

This problem is addressed by a method for designing an index assignment matrix for use in multiple description coding of an information signal. The method is characterised by selecting a bandwidth for the index assignment matrix in dependence of transmission condition information relating to a transmission condition of a communication channel onto which a description of the information signal can be transmitted.

The problem is further addressed by an apparatus for use in the design of an index assignment matrix to be used in multiple description coding of an information signal, as well as by a computer program product. The inventive apparatus comprises a bandwidth selecting unit adapted to generate a signal indicative of a bandwidth of the index assignment matrix. The bandwidth selecting unit has an input adapted to receive transmission condition information indicative of a transmission condition on a communication channel onto which a description of the information signal can be transmitted. The bandwidth selecting unit is furthermore adapted to generate the signal indicative of the bandwidth in dependence of the transmission condition information. The bandwidth selecting unit moreover has an output adapted to output the signal indicative of the bandwidth.

The bandwidth of an index assignment matrix is a measure of the band of the matrix, and can, for a square matrix in the two-dimensional case, be defined as the number of adjacent diagonals to which the non-zero elements of the matrix are confined. A similar definition of the bandwidth can be made for a non-square matrix, in two or more dimensions. Alternative definitions of the bandwidth may also be used.

By the inventive method and apparatus is achieved that the processing power and/or processing time required for the design of an index assignment matrix is greatly reduced. Since a bandwidth of the matrix is selected in dependence of transmission condition information, there is no need for costly simulations.

Once a bandwidth has been selected, the design of the index assignment matrix can be performed according to an index assignment algorithm, which could for example be a prior art index assignment algorithm.

Since the processing power required to design an index assignment matrix is greatly reduced by the invention, an index assignment matrix used for encryption (or decryption) onto a transmission interface can be redesigned at low processing cost. The optimal design of an index assignment matrix of an encoder or decoder operation according to multiple description coding depends on the transmission conditions in which the encoder is operating. Since transmission conditions in most communications systems vary over time, it is desirable to enable adjustment of the index assignment matrix to such varying transmission conditions in an on-line fashion. By the low-processing-cost inventive method and apparatus, such on-line adjustment to transmission conditions may efficiently be performed.

In one aspect of the invention, the selecting of a bandwidth comprises determining a root of a polynomial, wherein the coefficients of the polynomial are defined in dependence of the transmission condition information. Since finding a root of a polynomial only requires a few processing steps, this embodiment is processing power efficient.

In another aspect of the invention, the selecting of a bandwidth comprises accessing a memory in which is stored information corresponding to a table over possible values of a transmission condition and corresponding suitable bandwidth values. In this embodiment, the selecting of a bandwidth further comprises comparing the transmission condition information for which a bandwidth is to be selected to the possible values of the transmission condition stored in the memory; and selecting the bandwidth in accordance with the information stored in the memory.

The invention may for example be applied in encoders and/or decoders of varying communications systems. When the invention is applied in a communications system in an on-line fashion, transmission condition information could advantageously be received from a node in the communications system. The invention may also be applied in an apparatus for determining suitable bandwidths of index assignment matrices for multiple description coding at different transmission conditions.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic illustration of a communications system wherein diversity is employed.

FIG. 2 schematically illustrates an encoder and a decoder operating according to a multiple description coding using two different descriptions of an information signal x.

FIG. 3a illustrates the mapping performed by an exemplary central quantizer.

FIG. 3b illustrates the mapping performed by a resolution constrained central quantizer.

FIG. 3c illustrates the mapping performed by an entropy constrained central quantizer.

FIG. 4 illustrates an example of an index assignment matrix.

FIG. 5 schematically illustrates a method according to the invention.

FIG. 6a illustrates an embodiment of one of the steps of the method of FIG. 5 in more detail.

FIG. 6b illustrates an embodiment of one of the steps of the method of FIG. 5 in more detail.

FIG. 6c illustrates an embodiment of one of the steps of the method of FIG. 5 in more detail.

FIG. 7 schematically illustrates an apparatus comprising a bandwidth selecting unit.

FIG. 8a schematically illustrates an embodiment of a bandwidth selecting unit.

FIG. 8b schematically illustrates an embodiment of a bandwidth selection unit.

FIG. 9 schematically illustrates an apparatus comprising a bandwidth selecting unit connected to a matrix design unit for designing an index assignment matrix.

FIG. 10 shows an example of an index assignment matrix (left) for nested index assignment and corresponding side cell patterns (right).

### DETAILED DESCRIPTION

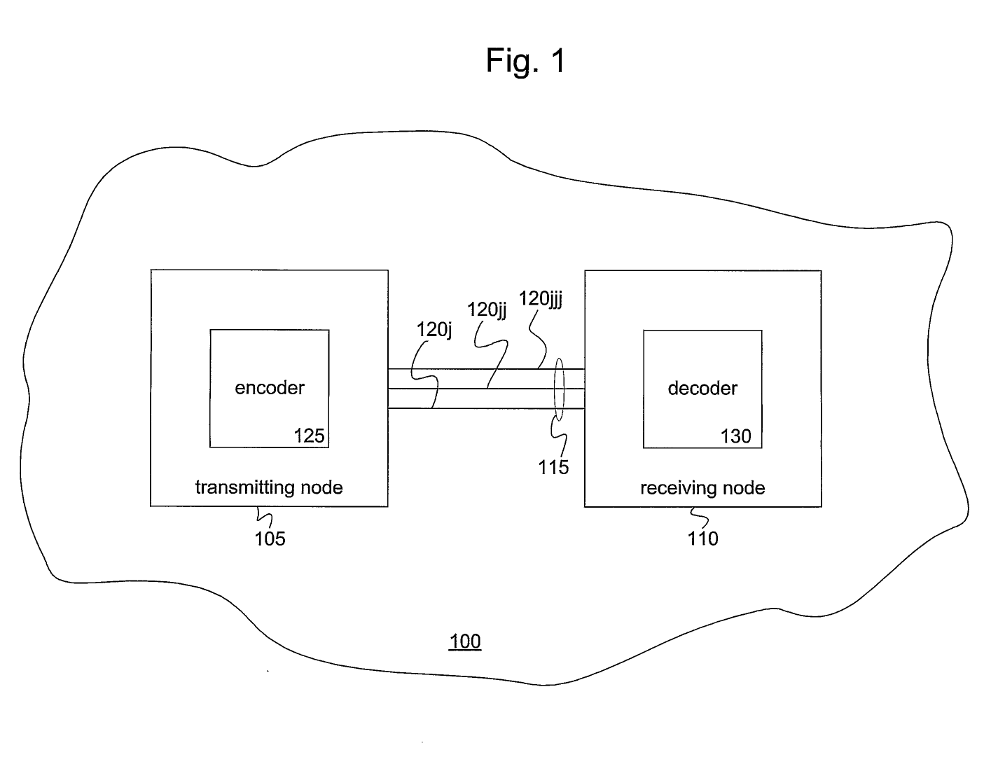

A communication system 100 comprising a first communication node 105 and a second communication node 110 is schematically illustrated in FIG. 1. First communication node 105 and second communication node 110 can communicate with each other over an interface 115 which employs diversity. Interface 115 could have any n>1 communication channels 120—in FIG. 1, interface 115 is shown to comprise three different communication channels 120^{(j)}. Both first and second communication nodes 105 and 110 could typically act as both a receiving node and a transmitting node. However, in order to simplify the description of the invention, first communication node 105 will in the following be described as a transmitting node 105, and second communication node 110 will in the following be described as a receiving node 110. Transmitting node 105 comprises an encoder 125 and receiving node 110 comprises a decoder 130.

Any number of descriptions can be used by a system operating according to multiple description coding. However, in order to simplify the description of the invention, the invention will in the following be described in terms of a system using two different descriptions transmitted over two different communication channels 120. Furthermore, the description will mainly focus on the symmetrical case, where the number of possible values onto which the information signal can be mapped is the same for both descriptions, as is the probability of erasure, w. It should however be understood that the invention may be generalised to any number of descriptions of an information signal, as well as to a non-symmetrical case.

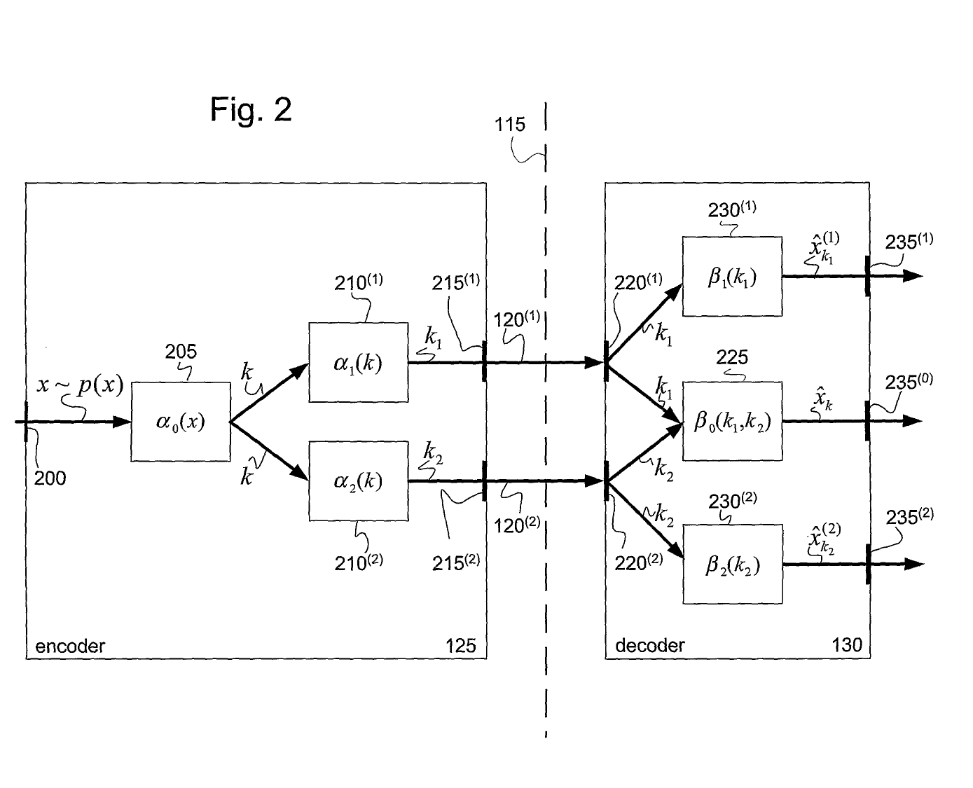

An encoder 125 and a decoder 130 operating according to a multiple description coding using two different descriptions of an information signal x is schematically illustrated in FIG. 2. The encoder 125 of FIG. 2 has an input 200 for receiving an information signal x having a probability density function p(x). The encoder 125 further has a central quantizer 205, arranged to map a sample of the information signal x onto a central quantizer index k, where kε{1, . . . , r} and r is the number of central quantizer cells, i.e. the number of quantization levels of the central quantizer 205. The mapping of the central quantizer 205 is denoted α₀(x).

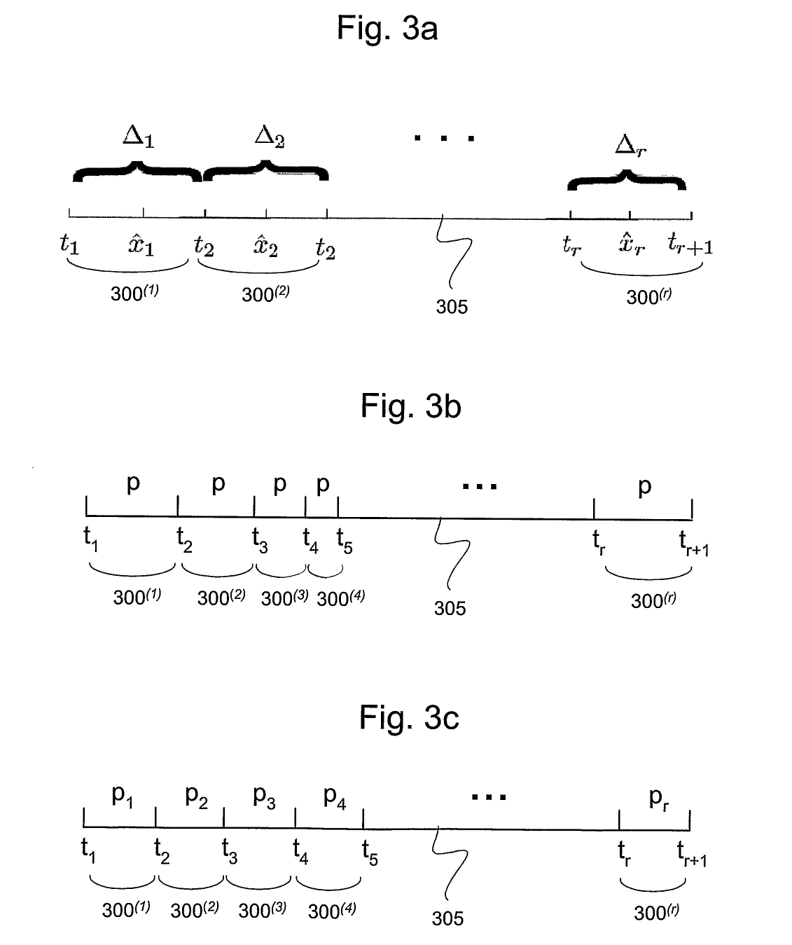

The mapping performed by an exemplary central quantizer 205 is illustrated in FIG. 3a. Possible values of the scalar source represented by the information signal x to be quantised are shown along an axis 305 in FIG. 3a. The central quantizer 205 described by FIG. 3a has r cells 300. Each central quantizer cell 300 is indexed k and has cell boundaries [tₖ, tₖ₊₁) along the axis 305, where k is an integer value between 1 and r, and t is a vector of cell boundaries. A central quantizer cell 300^{(k)} represents the possible values of the information signal x which the central quantizer will map onto the central quantizer index k. The length Δₖ of the k^{th} central quantizer cell 300^{(k)} is Δₖ=tₖ₊₁−tₖ. The length Δₖ is often referred to as the extent Δₖ of the cell 300^{(k)}. Each central quantizer cell 300 has an associated reconstruction point \hat{x}ₖ, where \hat{x}ₖ is a real number. The reconstruction point \hat{x}ₖ corresponds to the value which will be used by a decoder 130 to reconstruct a corresponding sample of x upon receipt of the central quantizer index k, and will in the following be referred to as a central reconstruction point \hat{x}ₖ.

A central quantizer 205 typically operates under a constraint on either entropy or resolution. The resolution of a central quantizer 205 is constrained if the number of central reconstruction points \hat{x}ₖ is constraint. For a resolution constrained central quantizer 205, all central quantizer cell 205 have the same probability, and the same number of bits are used to encode each central quantizer index k. Hence, a resolution constrained quantizer operates at a fixed rate. The condition on equal probability can be achieved by using a variable cell extent along the real axis 305 representing the values of the information signal x to be quantized. Resolution constrained central quantizer 205 can for example advantageously be used for delay-sensitive communication services.

The entropy of a central quantizer 205 is constrained if an average rate R_{average} is fixed. Hence, the momentary rate R may vary with time, as long as the average rate R_{average} over a specified time is fixed (the entropy constrained central quantizer generally requires a buffer, and the specified time depends on the size of the buffer). For an entropy constrained central quantizer 205, the extent Δ of all quantization cells 300 is the same. This implies that for the common situation where the information signal x to be quantized has a non-uniform probability density function, the probability will vary between different central quantizer cells 300. In order to optimize the allocation of bits, a variable length of the codewords should preferably be used—this can be obtained by so-called entropy coding (e.g. Huffman coding, arithmetic coding, and so on). Entropy constrained central quantizers 205 are typically used in communication services for which a certain delay is acceptable.

The mapping of a resolution constrained central quantizer 205 is schematically illustrated in FIG. 3b, where the different central quantizer cells 300 are of different extents Δₖ, and the probability p of the value of information signal x to fall within the different central quantizer cells 300 is constant. The length b of the code word describing an index k is the same for each cell. The mapping of an entropy constrained quantizer 205 is illustrated in FIG. 3c, wherein different central quantizer cells 300 are of the same extent Δ, and the probability pₖ of the value of the information signal x to fall within a quantizer cell 300^{(k)} varies between different quantizer cells 300. The length bₖ of a code word describing an index k varies between different cells 300, where the length bₖ is smaller for code words k having a higher probability.

The central quantizer 205 illustrated in FIG. 3 is an entropy constrained quantizer which is optimal in the high rate sense, i.e., the central reconstruction points \hat{x}ₖ lie in the middle of each cell 300:

$${\hat{x}}_{k} = \frac{( {t}_{k + 1} + {t}_{k} )}{2} = {t}_{k} + \frac{1}{2} {Δ}_{k} . \qquad ( 1 a )$$

For a resolution constrained central quantizer 205, a central reconstruction point \hat{x}ₖ can be computed by using weighting with the source probability density function p(x), i.e:

$${\hat{x}}_{k} = \frac{{\int }_{{t}_{k}}^{{t}_{k + 1}} xp ( x ) d x}{{\int }_{{t}_{k}}^{{t}_{k + 1}} p ( x ) d x} \qquad ( 1 b )$$

Returning to FIG. 2, the encoder 125 of FIG. 2 further comprises two side coders 210⁽¹⁾ and 210⁽²⁾, which are both arranged to receive the central quantizer output, i.e. the central quantizer indices kε{1, . . . , r} obtained by the mapping α₀(x). Side coder 210⁽¹⁾, hereinafter referred to as first side coder 210⁽¹⁾, is arranged to map an index k from the central quantizer 205 onto a first side coder cell index k₁. Side coder 210⁽²⁾, hereinafter referred to as second side coder 210⁽²⁾, is arranged to map the index k from the central quantizer 205 onto a second side coder cell index k₂. These mappings are referred to as α₁(k) and α₂(k), respectively. The number of cells in first side coder 210⁽¹⁾ is denoted M₁, and the number of cells in second side coder 210⁽²⁾ is denoted M₂. In other words, when a central quantizer index k is received by the first side coder 210⁽¹⁾, the first side coder 210⁽¹⁾ will map this index k onto a first side coder cell index k₁ε{1, . . . , M₁}, while if the same central quantizer index k is received by the second side coder 210⁽²⁾, the second side coder 210⁽²⁾ will map this index k onto a second side coder cell index. k₂ε{1, . . . , M₂}. In order to simplify the description, it will hereinafter be assumed that M₁=M₂=M, i.e. that the number of cells in the first side coder 210⁽¹⁾ is the same as the number of cells in the second side coder 210⁽²⁾, and the MDC encoder 125 is symmetrical. However, the invention is equally applicable to multiple description coding wherein Mⱼ_{ᵢ}≠Mⱼ_{ⱼ}.

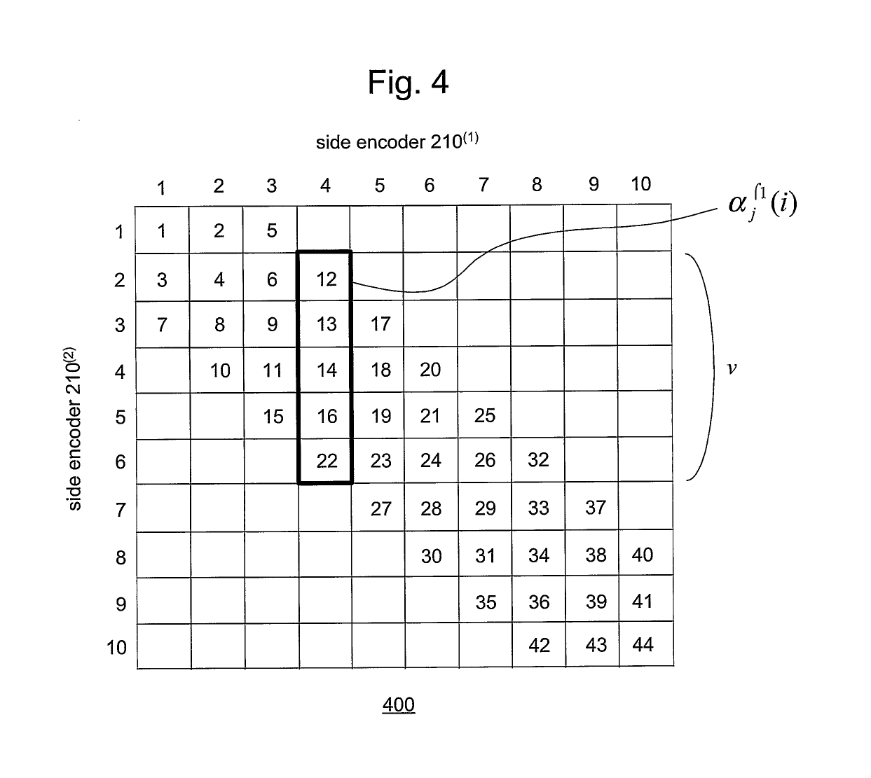

As shown in FIG. 4, the mappings α₁(k) and α₂(k) can be illustrated by way of a matrix, which in the following will be referred to as the index assignment matrix 400 (in the n-dimensional case, where the information signal x is encoded into n different descriptions which are transmitted over the interface 115, the index assignment matrix 400 will be an II-dimensional matrix). In the index assignment matrix 400 of FIG. 4, the number of central quantizer indices k is 44, i.e. r=44, whereas the number of side quantizer cells is 10 for each side coder 210, i.e. M₁=M₂=10. A side coder cell is generally denoted αⱼ⁻¹(i), where j is the side coder identity and i represents a value of the side coder cell index kⱼ. In FIG. 4, the first side coder cell αⱼ⁻¹(i) having index 4, i.e. α₁⁻¹(4), has been marked in bold, and corresponds to the set {12, 13, 14, 16, 22}. Hence, when the central quantizer index k takes any of the values in this set, then the first side coder cell index takes the value 4, k₁=4. The mapping of a central quantizer index k onto a first and second side coder cell index k₁ and k₂ will yield a side coder cell index pair (k₁, k₂). In two-dimensional multiple description coding, a side coder cell index pair uniquely defines a central quantizer index k. For example, the side coder cell index pair (4, 5) of FIG. 4 uniquely defines the central quantizer index 16.

In a situation where the number of central quantizer cells r, as well as the number of side coder cells M, are known, the mappings α₁(k) and α₂(k) of the central quantizer indices k can be made in a number of different ways. Different ways of filling the index assignment matrix 400 give rise to different distortions of the decoded information signal x on the decoder side of the interface 115, as will be further discussed below. As mentioned above, V. A. Vaishampayan has shown, in “Design of multiple description scalar quantizers”, IEEE Transactions on Information Theory, vol. 39, pp. 821-834, May 1993, that the linear index assignment algorithm and the nested index assignment algorithm generally yield good results with low distortions. Other index assignment algorithms that have also proven to be good are for example the herringbone index assignment (see e.g. T Berger-Wolf and E. Reingold, “Index assignment for multichannel communication under failure,” IEEE Transactions on Information Theory, vol. 48, pp. 2656-2668, October 2002.), the staggered index assignment (see e.g. C. Tian and S. Heinconi, “Universal multiple description scalar quantization: analysis and design,” IEEE Transactions on Information Theory, vol. 50, pp. 2089-2102, 2004) and the Balogh index assignment (J. Balogh and J. A. Csirik, “Index assignment for two-channel quantizaion,” IEEE Transactions on Information Theory, vol. 50, pp. 2737-2751, 2004). The index assignment matrix 400 of FIG. 4 has been generated by means of the herringbone index assignment algorithm.

By altering either the number of side code cells M, or the number of central quantizer cells r of an index assignment matrix 400 (or both), the redundancy of any transmission using the index assignment matrix 400 will change. At the same time, the base rate R_{base} will change, the base rate being the rate at which pure information is transmitted:

R_{base}=R−R_{redundancy}, (2)

where R is the total rate and R_{redundancy} is the part of the total rate R which is used for transmission of redundant information.

Once again returning to FIG. 2, the first and second side coders 210⁽¹⁾ and 210⁽²⁾ are each connected to an output 215W, referred to as output 215⁽¹⁾ and 215⁽²⁾, respectively. Although the outputs 215⁽¹⁾ and 215⁽²⁾ are illustrated in FIG. 2 to be two separate outputs, the outputs 215⁽¹⁾ and 215⁽²⁾ may alternatively use the same physical output 215 (different logical outputs 215⁽¹⁾ and 215⁽²⁾ could then for example be achieved by employing transmission from the same physical output 215 at different times, or at different frequencies). Outputs 215⁽¹⁾ and 215⁽²⁾ are arranged to transmit the indices k₁ and k₂, respectively, to the encoder 130 over the channels 120⁽¹⁾ and 120⁽²⁾ of interface 115, respectively.

The decoder 130 of FIG. 2 has two different inputs 220⁽¹⁾ and 220⁽²⁾, arranged to receive signals from the first and second side coders 210⁽¹⁾ and 210⁽²⁾, respectively, and to retrieve the first and second side coder indices k₁ and k₂ respectively. As with outputs 215⁽¹⁾ and 215⁽²⁾ of encoder 125, the inputs 220⁽¹⁾ and 220⁽²⁾ may use the same, or different, physical inputs 220. The decoder 130 further comprises a central decoder 225, as well as a first side decoder 230⁽¹⁾ and a second side decoder 230⁽²⁾. Input 220⁽¹⁾ is arranged to convey any received first side coder cell index k₁ to the first side decoder 230⁽¹⁾ as well as to a central decoder 225, whereas the second input 220⁽²⁾ is arranged to convey any received second side coder indices k₂ to the second side decoder 230⁽²⁾ as well as to the central decoder 225. Central decoder 225 is arranged to perform a mapping of the index pair (k₁, k₂) onto a central quantizer index k. Typically, the central decoder 225 is further arranged to determine the central quantizer reconstruction point \hat{x}ₖ (cf. expressions (1a) and (1b)), and to output a signal indicative of the reconstruction point \hat{x}ₖ onto a central decoder output 235⁽⁰⁾ to which the central decoder 225 is connected. The mapping performed by the central decoder 225 in order to determine the reconstruction point \hat{x}ₖ from the central quantizer index k is denoted β₀(k₁,k₂). The side decoders 230^{(j)} are ̂(i) arranged determine a side coder reconstruction point \hat{x}ₖ_{ⱼ}^{(j)} from the received side coder cell index kⱼ, and to deliver a signal indicative of the side coder reconstruction point xₖ_{ⱼ}^{(j)}. The mapping performed by a side decoder 230^{(j)} when determining the side coder reconstruction point xₖ_{ⱼ}^{(j)} is denoted βⱼ(kⱼ). First side decoder 235⁽¹⁾ is connected to a first side coder output 235⁽¹⁾ and second side coder 235⁽²⁾ is connected to a second side coder output 235⁽²⁾ (The outputs 235 may use the same, or different, physical outputs).

In case the central quantizer 205 and side coders 210 are entropy constrained, each side coder 210 could advantageously be connected to an entropy coder, which in turn would be connected to one of the outputs 215. The decoder 230 would then advantageously comprise two entropy decoders, each connected to an input 220^{(j)} and arranged to retrieve a side coder cell index kⱼ.

The encoder 125 and decoder 130 of FIG. 2 are adapted to multiple description encoding/decoding using two different descriptions. When n descriptions of the information signal x are used, an encoder 125 would include n side coders 120. A decoder 130 would preferably include (2ⁿ−1) decoders 225/230, since there should preferably be one decoder for each possible description subset that may be received.

If both the first and second side coder indices k₁ and k₂ in a side coder cell index pair are safely received by the decoder 130, the central decoder 225 can retrieve the central quantizer index k corresponding to the side coder cell index pair (k₁, k₂) by use of the applicable index assignment matrix 400. From the value of the retrieved central quantizer index k, a central reconstruction point \hat{x}ₖ can be obtained as the corresponding value of the information signal x (cf. FIG. 3a).

Disturbances generally occur, more or less frequently, on a transmission interface 115, and the probability of erasure, w, on an interface 115 is generally non-zero. When only one of the side coder indices of a side coder cell index pair (k₁, k₂) has been received, the central quantizer index k corresponding to the side coder cell index pair (k₁, k₂) can generally not be uniquely determined. However, information about the value of the information signal x can still be obtained via the applicable index assignment matrix 400. For example, referring to the example of an index assignment matrix 400 shown in FIG. 4, if the first side decoder 230⁽¹⁾ receives the first side cell coder index k₁=4, it can be determined that the value of the central quantizer index falls within the set {12, 13, 14, 16, 22}. A reconstructed value of the information signal x, referred to as a side coder reconstruction point \hat{x}ᵢ^{(j)} (where kⱼ=i), may be obtained under the condition that the central quantizer index k falls within this set. Typically, the side coder reconstruction point \hat{x}ᵢ^{(j)} falls outside this set, but within the extent of the side coder cell αⱼ⁻¹(i).

As opposed to the central quantizer cells 300, a side coder cell αⱼ⁻¹(i) is typically not a continuous interval but includes of a set of disjoint intervals. The side coder cell extent can be defined as an interval [t_{min(α}_{ⱼ}_{^{−1}}_{(i)), t}_{max(α}_{ⱼ}_{^{−1}}₍ᵢ₎₎₊₁), where j=1, 2 is the side coder identity and i is a value of the side coder cell index kⱼ. The side coder cell extent is sometimes referred to as the diameter of the side coder cell.

When only one of the side coder indices of a side coder cell index pair (k₁, k₂) is received by a decoder 130, an estimated value of the information signal x represented by the side coder cell index pair can be obtained from the side coder reconstruction point, \hat{x}ᵢ^{(j)}, which may be determined as follows:

$${\hat{x}}_{i}^{( j )} = \frac{{\sum }_{k ∈ {α}_{j}^{- 1} ( i )} {\int }_{{t}_{k}}^{{t}_{k + 1}} xp ( x ) d x}{{\sum }_{k ∈ {α}_{j}^{- 1} ( i )} {\int }_{{t}_{k}}^{{t}_{k + 1}} p ( x ) d x} , \qquad ( 3 )$$

where j is the side coder identity and i is a value of the received side coder cell index kⱼ of the pair.

When the index assignment matrix 400 of FIG. 4 is completely filled, the number of quantizer cells 300 will be M×M. Thus, if both side coder indices k₁ and k₂ are received by a decoder 130, the base rate R_{base} will in this case be at its highest. Redundancy, on the other hand, will be at its lowest (zero) when the index assignment matrix 400 is completely filled. If only one of the side coder cell indices k₁ and k₂ is received by the decoder 130, the uncertainty of which central quantizer index k gave rise to the received side coder cell index kⱼ will in this situation be high, since the number of central quantizer indices k in a side coder cell αⱼ⁻¹(i) will take its greatest value, i.e. be equal to M. The uncertainty of which central coder index gave rise to the side coder cell index kⱼ further depends on the pattern by which the central quantizer indices k have been mapped to the side coder cells—if the extent of the side coder cell αⱼ⁻¹(i) is large, then the uncertainty is greater than if the extent is low. On the other extreme, by filling only one diagonal of the index assignment matrix 400, the base rate R_{base} will, for a given total rate R, be at its lowest—and redundancy will be at its highest, since each central quantizer index k will be uniquely defined by each of the side coder indices. Hence, by altering the number r of central quantizer cells 300, as well as altering the way these r central quantizer cells 300 are mapped onto the side coder cells αⱼ⁻¹(i), a trade-off between redundancy and base rate R_{base} for a given number M of side coder cells αⱼ⁻¹(i) can be obtained. Alternatively, for a given number r of central quantizer cells 300, the number M of side coder cells αⱼ⁻¹(i) can be altered in order to obtain a good trade-off between redundancy and the base rate R_{base}.

The redundancy and the resolution/entropy of the encoder 125 both affect the distortion of the information signal x as received by the decoder 130. In a situation where the transmission interface 115 is stable and few transmitted packets will be lost or distorted during transmission, it is desirable to keep the redundancy low, in order to obtain a high base rate R_{base} (high resolution/high entropy). However, when the transmission interface 115 is unstable, higher redundancy is desirable at the expense of base rate R_{base}.

The stability of a communication channel 120 generally varies significantly with time, and the possibility of adjusting the trade-off between redundancy and base rate R_{base} to the current transmission conditions would therefore be highly desirable. State-of-the-art methods of designing an index assignment matrix (see e.g. A. Vaishampayan, “Design of multiple description scalar quantizers”, IEEE Transactions on Information Theory, vol. 39, pp. 821-834, May 1993) are based on iteration, where a large number of iterations are required before convergence. High processing powers are therefore required for such methods. These index assignment matrix design methods are therefore generally not suitable for online adjustment of an index assignment matrix to current transmission conditions.

An index assignment matrix 400 is generally a band matrix, whose non-zero entries are confined to a diagonal band, wherein the diagonal band comprises a main diagonal and possibly further diagonals on either side of the main diagonal. According to the invention, the trade-off between redundancy and base rate R_{base} can be optimised for certain transmission conditions by means of an analytical function describing the side coder distortion dⱼ of an information signal x as a function of the bandwidth v of an index assignment matrix 400 to be used for the transmission of the information signal x. The bandwidth of an index assignment matrix is a measure of the band of the matrix, and can, for a square matrix in the two-dimensional case, be defined as the number of adjacent diagonals to which the non-zero elements of the matrix are confined. A similar definition of the bandwidth v can be made for a non-square matrix, in two or more dimensions. For an index assignment 400 wherein Mⱼ_{ᵢ}≠Mⱼ_{ⱼ}, the bandwidth of the index assignment matrix 400 could advantageously be expressed by means of an n-dimensional vector v, where n is the number of descriptions employed in the multiple description coding. A vector component vⱼ, j=1 . . . n, is an integer describing the bandwidth vⱼ of the index assignment matrix 400 in the jth dimension.

The bandwidth v can alternatively be defined as the number of central quantizer indices k in a typical side coder cell αⱼ⁻¹(i) of the index assignment matrix 400, where a “typical” side coder cell refers to a side coder cell at a sufficient distance from the matrix boundaries (“corners”). In other words, the bandwidth v represents the number of non-zero¹ central quantizer indices k in each typical (non-corner) row and column of the index assignment matrix 400. In an index assignment matrix 400 where the number M of side coder cells αⱼ⁻¹(i) is the same for all the side coders 210, the bandwidth v describes the number of diagonals in the band of the index assignment matrix 400. ¹ For example the linear index assignment algorithm may generate elements within the band that take the value zero. For purposes of determining the bandwidth v, such elements should be counted as non-zero elements.

Other, alternative, definitions of the bandwidth v of the index assignment matrix 400 may be used.

Optimisation problems relating to the trade-off between redundancy and base rate R_{base} in multiple description coding in different scenarios can be solved by means of an analytical function of the side coder distortion d at a very small processing power cost. Such scenarios could for example be
A) minimisation of the composite distortion dᵢ subject to a constraint on the entropy of side coder cell indices kⱼ for a particular probability of erasure w.
B) minimisation of the composite distortion dᵢ subject to a constraint on the resolution of the side coders 210^{(j)} for a particular probability of erasure w.
C) minimisation of the central distortion d₀ subject to a constraint on the entropy of the side coder cell indices kⱼ and a constraint on the side coder distortion dⱼ.
D) minimisation of the central distortion d₀ subject to a constraint on the resolution of the side coders 210^{(j)} and a constraint on the side coder distortion dⱼ.

Further optimisation scenarios may also be conceived.

In order to optimise an index assignment matrix 400 for particular transmission conditions, information relating to such transmission conditions is generally needed. Such information typically relate to the quality of the channel onto which the information signal x is to be transmitted, and can for example relate to the probability of erasure w (scenario A & B) on a transmission channel 120; to the average rate R_{average}^{(j)} available on a transmission channel 120^{(j)} for transmission by a side coder side 210^{(j)} (a constraint on the entropy can be seen as a constraint on the average rate R_{average}) (scenario A & C); or to the fixed rate R_{fixed}^{(j)} available on a transmission channel 120^{(j)} for transmission by a side coder 210^{(j)} (a constraint on the resolution of a side coder 120, i.e. a constraint on the number of side coder cells, M, can be seen as a constraint on the available fixed bit rate on the transmission channel 120^{(j)}) (scenario B & D).

In order to solve an optimisation problem relating to the trade-off between the redundancy and the base rate R_{base}, analytical functions describing the central distortion d₀ and the side coder distortions dⱼ will be very useful. The composite distortion dᵢ is a weighted function of the central distortion d₀ and the side coder distortions dⱼ (weighted for instance by the probability of erasure, see expression (4) below). As will be seen below, the side coder distortion can be expressed in terms of a measure of the band of an optimal index assignment matrix.

Composite Distortion dᵢ

The composite distortion dᵢ is a sum of all possible distortions resulting from all possible subsets of descriptions that may be received at the receiver, weighted by the probabilities of receiving each particular subset. For the two-channel, symmetrical case, the composite distortion dᵢ can be expressed as (using squared error criterion):

dᵢ=(1−w)²d₀+2(1−w)wdⱼ, (4)

for a given probability of erasure w. In expression (4), the factor (1−w)² corresponds to the probability of both side coder cell indices (k₁, k₂) arriving safely at the decoder 130 and 2(1−w)w corresponds to the probability that only one side coder cell index kⱼ arrives safely.
Central Coder Distortion d₀

Under the high rate assumption, i.e. assuming that the central reconstruction point \hat{x}ₖ corresponding to a central quantizer index k lies in the middle of the central quantizer cell 300^{(k)} (cf. expression (1)), the central quantizer distortion d₀ can be expressed as:

$${d}_{0} = \frac{1}{12} {\sum }_{k = 1}^{r} p ( {x}_{k} ) {Δ}_{k}^{3} , \qquad ( 5 )$$

where p(xₖ) is the source probability density function evaluated at the central reconstruction point \hat{x}ₖ and Δₖ is the extent of the central quantizer cell 300^{(k)}.

Using the concept of asymptotic fractional density quanta, the central distortion can be evaluated using an integral expression:

$${d}_{0} = \frac{1}{12} {\int }_{{t}_{1}}^{{t}_{r + 1}} p ( x ) {( Δ ( x ) )}^{2} d x , \qquad ( 6 )$$

where Δ(xₖ)≈Δₖ, and where Δ(x) is a function describing the value of the central quantizer cell extent if the reconstruction point had been given the value x. Δ(x), which can be referred to as the step size, is a function inversely proportional to the local density of the reconstruction points (centroids) x per unit length. Expression (6) is an analytical function by means of which values of the central distortion can easily be calculated.
Side Coder Distortion dⱼ

An analytical function describing the side coder distortion dⱼ can, as will be seen below, be obtained by making the following, justifiable, assumptions:
1) the probability density function of the source can be approximated as constant within a side coder cell extent of the index assignment matrix. This assumption can alternatively be expressed as the assumption that the central quantizer cell extent Δₖ is approximately constant within the side coder cell extent, and will be referred to as a high rate assumption.
2) for purposes of estimating the side coder distortion dⱼ, it is assumed that the pattern of central quantizer indices k within a side coder cell αⱼ⁻¹(i) of the index assignment matrix 400 is one of a set of possible patterns, and that the pattern of indices of different side coder cells is ordered within the index assignment matrix 400.
   Assumption 2) is made for purposes of estimating the side coder distortion. However, for other purposes, such as for mapping the central quantizer indices k onto the index assignment matrix 400, this assumption would generally not be used.

A special case of assumption 2) is to assume, for purposes of estimating the side coder distortion, that the pattern of indices within a side coder cell extent is constant for a particular side coder 210. In order to simplify the description, this special case is the case which will be considered below.

The side coder distortion dⱼ of side coder 210^{(j)} is given by:

$$\begin{matrix}{d}_{j} = {\int }_{{t}_{1}}^{{t}_{r + 1}} p ( x ) {( x - {\hat{x}}_{{α}_{j} ( {α}_{0} ( x ) )}^{( j )} )}^{2} d x \\ = {\sum }_{k = 1}^{r} {\int }_{{t}_{k}}^{{t}_{k + 1}} p ( x ) {( x - {\hat{x}}_{{α}_{j} ( k )}^{( j )} )}^{2} d x ,\end{matrix} \qquad ( 7 )$$

where \hat{x}_{α}_{ⱼ}_{(α}_{₀}₍ₓ₎₎^{(j)} is the side coder reconstruction point of side coder 210^{(j)} obtained from a value x of the information signal (cf. expression (3)).

The integral of expression (7) cannot easily be solved analytically. Values of dⱼ have been derived in the prior art by means of numerical methods, e.g. in V. A. Vaishampayan, “Design of multiple description scalar quantizers”, IEEE Transactions on Information Theory, vol. 39, pp. 821-834, May 1993. However, such numerical methods require high processing powers.

### Adopting Assumption 1)

By adopting assumption 1) above, expression (7) can be expressed as:

$$\begin{matrix}{d}_{j} = {\sum }_{k = 1}^{r} {\int }_{{t}_{k}}^{{t}_{k + 1}} p ( x ) {( x - {\hat{x}}_{{α}_{j} ( k )}^{( j )} )}^{2} d x \\ \approx {\sum }_{k = 1}^{r} p ( {x}_{k} ) {\int }_{{t}_{k}}^{{t}_{k + 1}} {( x - {\hat{x}}_{{α}_{j} ( k )}^{( j )} )}^{2} d x \\ = {\sum }_{i = 1}^{M} p ( {\hat{x}}_{i}^{( j )} ) {\sum }_{k ∈ {α}_{j}^{- 1} ( i )} {\int }_{{t}_{k}}^{{t}_{k + 1}} {( x - {\hat{x}}_{i}^{( j )} )}^{2} d x ,\end{matrix} \qquad ( 8 )$$

where j=1,2 is the side coder identity.

By introducing mⱼ(i) as the smallest central quantizer index k in a side coder cell αⱼ⁻¹(i), i.e. mⱼ(i)=min(αⱼ⁻¹(i)), by introducing hⱼ(i) as the normalised pattern of central quantizer indices k within a side coder cell αⱼ⁻¹(i) of the index assignment matrix 400 expressed as

hⱼ(i)=(αⱼ⁻¹(i)−mⱼ(i)), (9)

and by substituting the information signal x with x=y+tₘ_{ⱼ}₍ᵢ₎, as well as the side coder reconstruction point \hat{x}ᵢ^{(j)} with \hat{x}ᵢ^{(j)}=ŷᵢ^{(j)}+tₘ_{ⱼ}₍ⱼ₎, we get

$${d}_{j} = {\sum }_{i = 1}^{M} p ( {\hat{x}}_{i}^{( j )} ) {\sum }_{k ∈ {h}_{j} ( i )} {\int }_{k {Δ}_{i}}^{( k + 1 ) {Δ}_{i}} {( y - {\hat{y}}_{i}^{( j )} )}^{2} d y , \qquad ( 10 )$$

where Δᵢ is the extent of the central quantizer cells 300 within the side coder cell αⱼ⁻¹(i).

The distortion of a single side coder cell αⱼ⁻¹(i) can be expressed as:

$${\sum }_{k ∈ {h}_{j} ( i )} {\int }_{k {Δ}_{i}}^{( k + 1 ) {Δ}_{i}} {( y - {\hat{y}}_{i}^{( j )} )}^{2} d y = {Δ}_{i}^{3} {\sum }_{k ∈ {h}_{j} ( i )} ( \frac{1}{3} + k + {k}^{2} ) - {Δ}_{i}^{2} {\hat{y}}_{i}^{( j )} {\sum }_{k ∈ {h}_{j} ( i )} ( 1 + 2 k ) + \vert {h}_{j} ( i ) \vert {{Δ}_{i} ( {\hat{y}}_{i}^{( j )} )}^{2} , \qquad ( 11 )$$

where |hⱼ(i)| is the cardinality of the set hⱼ(i), i.e. number of non-zero indices in the side coder cell αⱼ⁻¹(i).

Differentiation of (11) with respect to ŷᵢ^{(j)} yields the following expression for ŷᵢ^{(j)} which minimises the contribution of one side coder cell αᵢ⁻¹(i) to the side coder distortion dⱼ:

$${\hat{y}}_{i}^{( j )} = \frac{{Δ}_{i} {\sum }_{k ∈ {h}_{j} ( i )} ( 1 + 2 k )}{2 \vert {h}_{j} ( i ) \vert} . \qquad ( 12 )$$

ŷᵢ^{(j)} can be seen as a normalised side coder reconstruction point. A value of the corresponding side coder reconstruction point can be obtained via \hat{x}ᵢ^{(j)}=ŷᵢ^{(j)}+tₘ_{ⱼ}₍ⱼ₎ (see above).

Substituting (12) into (11) yields:

$${min}_{{\hat{y}}_{i}^{( j )}} {\sum }_{k ∈ {h}_{j} ( i )} {\int }_{k {Δ}_{i}}^{( k + 1 ) {Δ}_{i}} {( y - {\hat{y}}_{i}^{( j )} )}^{2} d y = {Δ}_{i}^{3} [ \begin{matrix}{\sum }_{k ∈ {h}_{j} ( i )} ( \frac{1}{3} + k + {k}^{2} ) - \\ \frac{1}{4 \vert {h}_{j} ( j ) \vert} {( {\sum }_{k ∈ {h}_{j} ( i )} ( 1 + 2 k ) )}^{2}\end{matrix} ] . \qquad ( 13 )$$

Thus, by substituting expression (13) into expression (10), a minimised expression of the side coder distortions dⱼ is obtained:

$$\begin{matrix}\begin{matrix}{d}_{j} = {\sum }_{i = 1}^{M} p ( {\hat{x}}_{i}^{( j )} ) \{ [ \begin{matrix}{\sum }_{k ∈ {h}_{j} ( i )} ( \frac{1}{3} + k + {k}^{2} ) - \\ \frac{1}{4 \vert {h}_{j} ( i ) \vert} {( {\sum }_{k ∈ {h}_{j} ( i )} ( 1 + 2 k ) )}^{2}\end{matrix} ] {Δ}_{i}^{3} \} \\ = {\sum }_{i = 1}^{M} p ( {\hat{x}}_{i}^{( j )} ) f ( v , i ) {Δ}_{i}^{3} ,\end{matrix} & ( 14 ) \\ where \text{:} & \\ f ( v , i ) = {\sum }_{k ∈ {h}_{j} ( i )} ( \frac{1}{3} + k + {k}^{2} ) - \frac{1}{4 \vert {h}_{j} ( i ) \vert} {( {\sum }_{k ∈ {h}_{j} ( i )} ( 1 + 2 k ) )}^{2} . & ( 15 )\end{matrix}$$

v is the bandwidth of the index assignment matrix 400. As mentioned above, the bandwidth v could be seen as the number of non-zero elements in a column or row of the index assignment matrix at a sufficient distance from the matrix boundaries. For example, for the index assignment matrix 400 of FIG. 4, v=5.

### Adopting Assumption 2)

As can be noted in expression (15), the coefficient of quantisation

$$\frac{f ( v , i )}{v}$$

depends on the side coder cell index i (that is, kⱼ), since the normalised pattern of indices hᵢ^{(j)} generally varies from one side coder cell to another side coder cell within the index assignment matrix 400. This dependency complicates the calculation of the side coder distortion dⱼ, when the number M of side coder cells αⱼ⁻¹(i) is large. However, we have noted that the dependency of the side coder cell index i can be neglected for purposes of estimating the side coder distortion dⱼ and thus that the normalised pattern of indices within a side coder cell extent of the index assignment matrix 400 can be approximated as constant within the same side coder 210^{(j)}. For a symmetrical case, the pattern of indices does not depend on the side quantizer index j. Hence, the normalised pattern of indices hᵢ^{(j)} can be replaced in expression (15) by an i-independent pattern of indices, h(v).

$$f ( v , i ) \approx f ( v ) == {\sum }_{k ∈ h ( v )} ( \frac{1}{3} + k + {k}^{2} ) - \frac{1}{4 v} {( {\sum }_{k ∈ h ( v )} ( 1 + 2 k ) )}^{2} . \qquad ( 16 )$$

h(v) is a typical pattern of an index assignment matrix 400, which pattern depends on the matrix bandwidth v and differs between different index assignment algorithms. h(v) approximates the geometry of the side coder cells αⱼ⁻¹(i) for a given bandwidth v, and will in the following be referred to as an average pattern of indices.

The average pattern of indices h(v) depends on the bandwidth v of the index assignment matrix 400. An average pattern of indices h(v) is given below for a number of different index assignment algorithms, see expressions (19)-(22).

From expressions (14) and (16), it is clear that the side coder distortions dⱼ can be approximated by the following integral under the high rate assumption that Δᵢ is small:

$$\begin{matrix}{d}_{j} \approx f ( v ) {\int }_{{t}_{1}}^{{t}_{r + 1}} p ( {x}^{′} ) {( Δ ( {x}^{′} , v ) )}^{2} d {x}^{′} \\ = \frac{f ( v )}{v} {\int }_{{t}_{1}}^{{t}_{r + 1}} p ( x ) {( Δ ( x , v ) )}^{2} d x , ,\end{matrix} \qquad ( 17 )$$

where

$$d {x}^{′} = \frac{d x}{v} ,$$

and the step size Δ(x,v) is a function describing the central quantizer cell extent Δₖ if the reconstruction point \hat{x}ₖ had been given the value x in an index assignment matrix 400 having bandwidth v. In other words, Δ(x,v) is inversely proportional to the local density of the reconstruction points (centroids) x per unit length for given bandwidth

$$v \cdot \frac{f ( v )}{v}$$

can be considered a coefficient of quantisation:

It should be noted that expression (15) and (17) hold equally for the nested, linear and herringbone index assignments. For the staggered index assignment, the side coder distortion dⱼ can be expressed as:

$${d}_{j} = \frac{{c}_{s}}{2} {\int }_{{t}_{1}}^{{t}_{r + 1}} p ( x ) {Δ ( x , v )}^{2} d x . \qquad ( 18 )$$

where cₛ is a constant and

$$d {x}^{′} = \frac{d x}{v} = \frac{d x}{2} ,$$

since the bandwidth v=2 for the staggered index assignment.

In order to obtain an expression for the average pattern of indices h(v), it is recognised that for most index assignment algorithms, including the linear, nested, herringbone, staggered and Balogh, |hⱼ(i)|=v for almost all i (since when v<<M, the boundary conditions may be neglected). By studying index assignment matrix patterns, we have found that the following approximations hold for some different index assignment algorithms. An example of how such results can be arrived at is given in Appendix 1.

For the herringbone index assignment (odd v):

$${h}_{j} ( i , v ) ≃ h ( v ) = … \\ \{ ( k - 1 ) \text{:} k = 1 , … , ( v - 1 ) / 2 \} ⋃ \{ ( v - 1 ) / 2 + 1 \} ⋃ \\ ⋃ \{ 3 ( v - 1 ) / 2 \} ⋃ \{ \frac{1}{2} ( 2 k - v ) ( v - 1 ) \text{:} k = ( v - 1 ) / 2 + 3 , … , v \} ; \qquad ( 19 )$$

where ∪ represents the union of two sets.

For the herringbone index assignment (even v):

hⱼ(i,v)≅h(v)= . . . {k−1:k=1, . . . , v/2}∪{(k−v/2)(v−1):k=v/2+1, . . . , v}; (20)

For the nested index assignment, where

$$z = \frac{1}{2} ( v - 1 )$$

hⱼ(i,z)≅h(z)= . . . {(k−1)(2z−1):k=1,2, . . . , z+1}∪{z(2z−1)+2(k−z−1):k=z+2, . . . , 2z+1}; (21)

For the linear index assignment, where

$$z = \frac{1}{2} ( v - 1 )$$

hⱼ(i,x)≅h(z)={(k−1)(z+1):k=1, . . . , z+1}∪{z(z−1)+z(k−z−1):k z+2, . . . , 2z+1} (22)

When the expressions (19)-(22) are entered into expression (16), the following expressions are obtained:

For the herringbone index assignment (odd v):

$$f ( v ) = \frac{1}{16} - \frac{9 v}{64} + \frac{5 {v}^{2}}{24} - \frac{5 {v}^{3}}{96} - \frac{{v}^{4}}{48} + \frac{5 {v}^{5}}{192} \qquad ( 23 )$$

For the herringbone index assignment (even v):

$$f ( v ) = \frac{{v}^{2}}{12} - \frac{{v}^{3}}{48} - \frac{{v}^{4}}{48} + \frac{5 {v}^{5}}{192} \qquad ( 24 )$$

For the nested index assignment:

$$f ( v ) = \frac{5 {v}^{6} - 8 {v}^{5} + 14 {v}^{4} - 16 {v}^{3} + 45 {v}^{2} + 24 v - 48}{192 v} \qquad ( 25 )$$

For the linear index assignment:

$$f ( v ) = \frac{4 {v}^{6} - 3 {v}^{4} + 18 {v}^{2} - 3}{192 v} \qquad ( 26 )$$

For the staggered index assignment, the constant cₛ is equal to

$${c}_{s} = \frac{2}{3} \qquad ( 27 )$$

By inserting one of the expressions (23)-(26) into expression (17), or expression (27) into expression (18), an analytic expression for the side coder distortion dⱼ is obtained which depends on the bandwidth v. This expression may be used in an optimisation scenario, in combination with the analytical expression for the central distortion d₀ given by expression (6), in order to obtain an optimal value of v under certain transmission conditions and constraints.

The analytical functions of the side coder distortions dⱼ and the central coder distortions d₀ can advantageously be used to derive a solution to a given design problem, wherein the solution is expressed in terms of a polynomial rooting resulting in a polynomial of which the real and positive roots can be rounded or truncated to an integer which corresponds to a value of the bandwidth v of the index assignment matrix 400.

In appendix 2, polynomials, to be used for the selection of the bandwidth v in order to obtain an optimal result, are derived from expressions (6), (17), (23)-(26) for different optimisation scenarios when the index assignment matrix 400 is a square matrix. Results of such calculations are given below. Other analytical functions derived by means of an analytical expression of the composite distortion d, could alternatively be used for determining a suitable bandwidth v.

### A/B) Minimisation of Composite Distortion Subject to an Entropy or Resolution Constraint

Minimisation of composite distortion dᵢ subject to a constraint on the entropy of the indices for the side coders, or, subject to a constraint on resolution, gives rise to the following polynomials (both optimisation problems result in the same polynomials):

For the nested index assignment:

5wv⁶−4wv⁵+8wv³−(37w+8)v²−36wv+96w=0 (28)

Linear index assignment:

2wv⁶−(5w+4)v²+3w=0 (29)

Herringbone index assignment (even v):

5wv⁴−2wv³−8wv+8w−8=0 (30)

Herringbone index assignment (odd v):

5wv⁵−2wv⁴−20wv²+(35w−8)v−18w=0 (31)

Thus, for certain transmission conditions expressed in terms of a certain value of the probability of erasure w, a value of the bandwidth v of the index assignment matrix 400 can be derived from a real and positive root of one of the polynomials (28)-(31), where the root would be rounded or truncated to an integer which corresponds to the bandwidth v.

The probability of erasure w should, in the polynomials (28)-(31), be expressed as the probability of erasure of a side coder cell index kⱼ of one of the descriptions. However, other ways of expressing the probability of erasure w over a communication channel 120 may be used when expressing the transmission conditions, such as the probability of erasure of a data packet transmitted over the communications channel 120. Such alternative expressions of the probability of erasure w can easily be converted into the probability of erasure of a side coder cell index kⱼ for purposes of determining the coefficients of the polynomials (28)-(31).

The optimisation scenario A) is typically interesting in systems where a certain transmission delay is acceptable and where the encoder 125 comprises a buffer, which is used in the adaptation of a varying bit rate of the central quantizer 205 and/or side coders 210(j) into a fixed bit rate available on the transmission channel 120^{(j)}.

Optimisation scenario B) is typically interesting in systems wherein a side coder 210 has a limited number of quantization levels, and where the probability of erasure w is known or can be estimated,

### C) Minimisation of Central Distortion Subject to Constraint on Side Coder Distortion and Rate

Minimisation of central distortion d₀ subject to a constraint on side coder distortion dⱼ and the rate R of the side coders 210^{(j)} gives rise to the following polynomials, where g=2^{2(h(X)-R)}, h(X) is the source differential entropy and dₛ is the maximum acceptable side order distortion, dⱼ<dₛ:

For the nested index assignment (odd v):

$$- \frac{1}{4} g - \frac{1}{8} gv - \frac{15}{64} {gv}^{2} + \frac{1}{12} {gv}^{3} + ( {d}_{s} - \frac{7}{96} g ) {v}^{4} + \frac{1}{24} {gv}^{5} - \frac{5}{192} {gv}^{6} = 0 \qquad ( 32 )$$

Linear index assignment (odd v):

$$\frac{1}{64} g - \frac{3}{32} {gv}^{2} + ( \frac{1}{64} g + {d}_{s} ) {v}^{4} - \frac{1}{48} {gv}^{6} = 0 \qquad ( 33 )$$

Herringbone index assignment (even v):

$$- \frac{1}{12} {gv}^{2} + ( \frac{1}{48} g + {d}_{s} ) {v}^{3} + \frac{1}{48} {gv}^{4} - \frac{5}{192} {gv}^{5} = 0 \qquad ( 34 )$$

Herringbone index assignment (odd v):

$$- \frac{1}{16} g + \frac{9}{64} gv - \frac{5}{24} {gv}^{2} + ( \frac{5}{96} g + {d}_{s} ) {v}^{3} + \frac{1}{48} {gv}^{4} - \frac{5}{192} {gv}^{5} = 0 \qquad ( 35 )$$

Thus, for a certain transmission condition expressed in terms of a certain available average bit rate R_{average} of the side coders 210^{(j)}, a value of the bandwidth v of the index assignment matrix 400 can be derived from a real and positive root of one of the polynomials (32)-(35), for a certain maximum side coder distortion dₛ. The root would be rounded or truncated to an integer which corresponds to the bandwidth v.

Optimisation scenario C) is typically interesting when the entropy of the side coders 210 is constrained and there is a requirement on the quality of the reconstruction for the case when only one of the descriptions is received, i.e. when a too coarse reconstruction is undesirable. By optimisation scenario C), an encoder/decoder can be designed which provides a guaranteed minimum quality when only one description is received.

### D) Minimisation of Central Distortion Subject to Constraint on Side Coder Distortion and Number of Side Coder Cells, M.

Minimisation of central distortion d₀ subject to a constraint on side coder distortion dⱼ and on the number of side coder cells M gives rise to the following polynomials, where

$$β = {( {\int }_{{t}_{1}}^{{t}_{r + 1}} {( p ( x ) )}^{\frac{1}{3}} d x )}^{3} :$$

For the nested index assignment (odd v):

$$\frac{1}{4} β - \frac{1}{8} β v - \frac{15}{64} β {v}^{2} + \frac{1}{12} β {v}^{3} + ( {d}_{s} {M}^{2} - \frac{7}{96} β ) {v}^{4} + \frac{1}{24} β {v}^{5} - \frac{5}{192} β {v}^{6} = 0 \qquad ( 36 )$$

Linear index assignment (odd v):

$$\frac{1}{64} β - \frac{3}{32} β {v}^{2} + ( \frac{1}{64} β + {d}_{s} {M}^{2} ) {v}^{4} - \frac{1}{48} β {v}^{6} = 0 \qquad ( 37 )$$

Herringbone index assignment (even v):

$$- \frac{1}{12} β {v}^{2} + ( \frac{1}{48} β + {d}_{s} {M}^{2} ) {v}^{3} + \frac{1}{48} β {v}^{4} - \frac{5}{192} β {v}^{5} = 0 \qquad ( 38 )$$

Herringbone index assignment (odd v):

$$- \frac{1}{16} β + \frac{9}{64} β v - \frac{5}{24} β {v}^{2} + ( \frac{5}{96} β + {d}_{s} {M}^{2} ) {v}^{3} + \frac{1}{48} β {v}^{4} - \frac{5}{192} β {v}^{5} = 0 \qquad ( 39 )$$

An optimal value of the number of side coder cells, M, depends on the available fixed bit rate on the transmission channels 120^{(j)} over which the side coder indices kⱼ are to be transmitted. Hence, a constraint on the number of side coder cells, M, can be seen as a constraint on the available fixed bit rate on the transmission channel 120^{(j)}. Thus, for a certain transmission condition expressed in terms of a certain number of side coder cells M, or as a fixed available bitrate R_{fixed} on the transmission channel 120^{(j)}, a value of the bandwidth v of the index assignment matrix 400 can be derived from a real and positive root of one of the polynomials (36)-(39), for a certain maximum side coder distortion dₛ. If not already an integer, the root would have to be rounded or truncated to an integer which corresponds to the bandwidth v.

Optimisation scenario D) is typically interesting when the resolution of the side coders 210 is constrained and there is a requirement on the quality of the reconstruction for the case when only one of the descriptions is received, i.e. when a too coarse reconstruction is undesirable. By optimisation scenario C), an encoder/decoder can be designed which provides a guaranteed minimum quality when only one description is received.

### General

When truncating or rounding the root obtained from one of the polynomials (28)-(39) in order to obtain a suitable value of the bandwidth v for a particular index assignment algorithm, it may be that the particular index assignment algorithm puts further constraints on the bandwidth v—typically that the bandwidth v be either even or odd. The truncating or rounding should advantageously take such further constraints into account. Furthermore, the index assignment algorithms considered here generally require that the bandwidth v is larger than one (if v=1, then the same information is transmitted by all side coders 210).

However, under certain circumstances, such as when the transmission conditions are very poor, the most advantageous usage of the transmission resources may in fact be that full redundancy is employed, and the applicable polynomial will then have a root suggesting that only one non-zero element should be used in each column or row of the index assignment matrix 400. In an implementation of the invention, the indication that the bandwidth v should equal 1 could result in that a special index assignment algorithm is applied which results in only one non-zero element in each column or row (full redundancy). Alternatively, when the indication is given that the bandwidth v should equal 1, a suitable value of the bandwidth v could be selected for the index assignment algorithm to be applied (preferably the lowest value of v that is applicable to the particular index assignment algorithm).

For some design scenarios, there might not be a root which would be feasible to use as the bandwidth v—there might not be any positive real root that does not indicate that the bandwidth v should equal zero. The lack of feasible roots typically indicates that the constraints of the design scenario are too tight. Appropriate measures could then be taken, such as changing the constraints, or using the lowest feasible value of the bandwidth v.

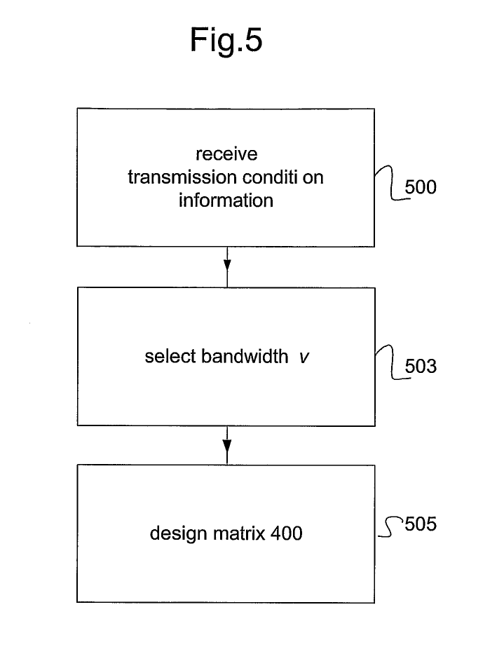

FIG. 5 schematically illustrates a method for designing an index assignment matrix according to the invention. In step 500, transmission condition information is received. When the method is performed in a node in a communications network in an on-line situation, the transmission condition information can advantageously be received from another node in the communications network or from a transmission condition determination unit in the node. When the method is performed in an off-line manner in order to determine a relation between transmission conditions and the optimal bandwidth v, the transmission condition information can for example be received from a memory, from an external source, or from an internal process.

In step 503, a bandwidth v of the index assignment matrix 400 to be designed is selected in dependence of transmission condition information relating to transmission conditions on a channel 120^{(j)} over which an information signal x, to be encoded by means of the index assignment matrix 400, is to be transmitted. Such transmission condition information could for example include information on the probability of erasure w; available average bitrate R_{average}; available fixed bitrate R_{fixed}; constraints on the side coder distortion dₛ or constraints on the central distortion d₀. The transmission condition information could for example have been received by a network node or an Operation and Management node in a communications system 100 and be based on the current situation in the communications system 100, or could for example have been derived from previous experience.

When a favourable bandwidth v has been selected, step 505 is entered, in which an index assignment matrix 400 having the selected bandwidth v is designed according to known algorithms: If the number Mⱼ of side coder cells αⱼ⁻¹(i) of a side coder 210^{(j)} is known, the number r of central quantizer cells 300 can be determined from the bandwidth v, and vice versa. The r central quantizer indices k can then be distributed within the index assignment matrix according to a selected index assignment algorithm. The central reconstruction points \hat{x}ₖ as well as the side coder reconstruction points \hat{x}ᵢ^{(j)} can be determined as described above.

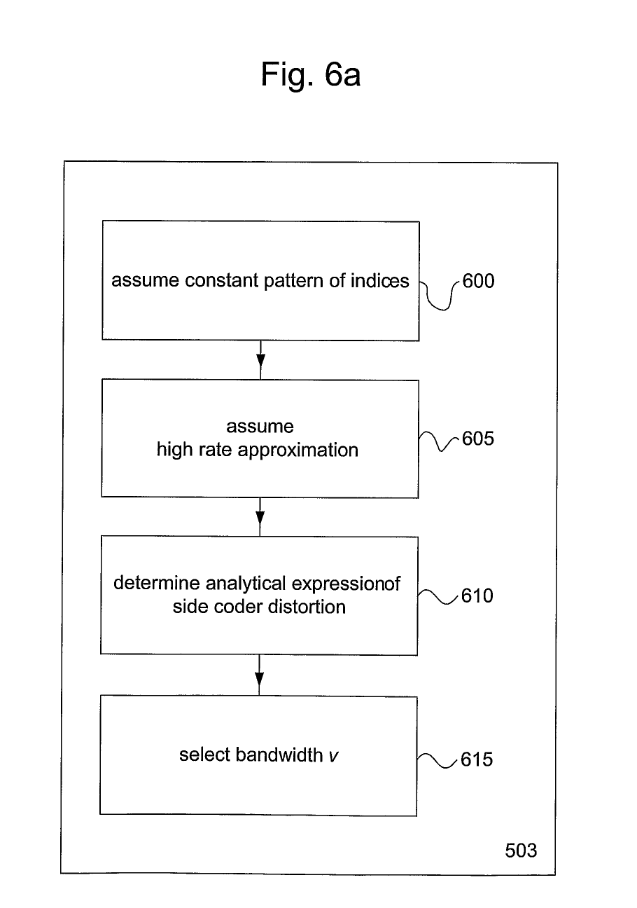

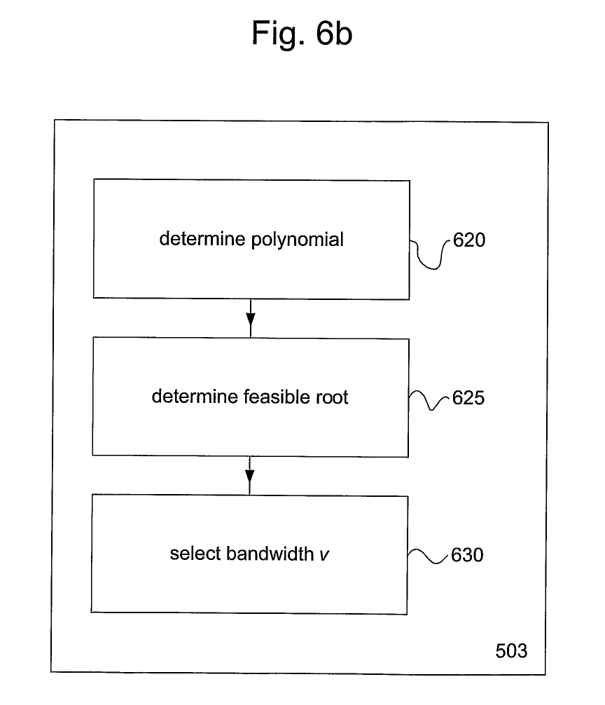

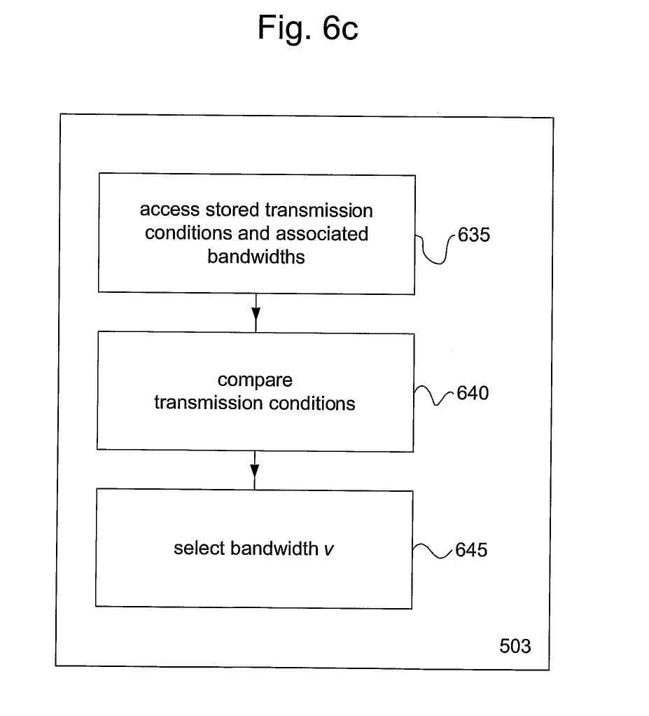

An embodiment of the step 503 of selecting the bandwidth v is illustrated in more detail in FIG. 6a. In the embodiment of step 503 illustrated in FIG. 6, step 503 comprises steps 600-615. In step 600, it is assumed, for purposes of determining the side coder distortion dⱼ, that the pattern of indices in a side coder cell αⱼ⁻¹(i) is approximately constant in the index assignment matrix 400, i.e. that the pattern of indices is approximately independent of the value i of the side coder cell index kⱼ (cf. expressions (19)-(22)). In step 605, the high rate approximation is assumed, i.e. that the probability density function p(x) of the source can be approximated as constant within a side coder cell extent of the index assignment matrix 400 (cf. expression (8)). In step 610, an analytical expression for the side coder distortion dⱼ is determined under the assumptions made in steps 600 and 605 (cf. expression (17)). In step 615, a bandwidth v of the index assignment matrix 400 that is favourable for a particular optimisation scenario is selected, using the analytical expression of the side coder distortion dⱼ and the transmission condition information (cf. expressions (28)-(39)).

In step 600 of FIG. 6a, it is assumed, for purposes of estimating the side coder distortion dⱼ, that the pattern of central quantizer indices k within a side coder cell αⱼ⁻¹(i) is constant within the index assignment matrix 400. This is a special case of assumption 2) above. The general case would be that it is assumed that the pattern of central quantizer indices k within a side coder cell αⱼ⁻¹(i) of the index assignment matrix 400 is one of a set of possible patterns, and that the pattern of indices of different side coder cells is ordered within the index assignment matrix 400. In the following, when reference is made to FIG. 6a, reference is made to both the general and the specific case of step 600.

FIG. 6a illustrates some inventive assumptions made to multiple description encoding theory that have proven to simplify the of index assignment matrix design in that a suitable or optimal value of the bandwidth v may be obtained by means of an analytical function. Other ways of obtaining an analytical function of the side coder distortion may also be conceived.

FIG. 6b, on the other hand, illustrates a method of solving an analytical function, in this ease a polynomial, in order to arrive at a suitable or optimal bandwidth v.

The method of FIG. 6b illustrates an embodiment of step 503 of FIG. 5. FIG. 6b comprises steps 620-630. In step 620, a polynomial to be used for selecting a suitable bandwidth v is determined in dependence of transmission condition information, cf. for example expressions (28)-(39). The polynomials of expression (28)-(39) have all been derived by using the method of steps 600-610 of FIG. 6. Other suitable polynomials could alternatively be used. In step 625, a feasible root of the polynomial determined in step 620 is determined, where a feasible root is a root that is real and positive, and preferably greater than 1. From this feasible root, a bandwidth v is selected in step 630. The simplest case is when the bandwidth v is given the truncated or rounded value of the root determined in step 625. However, in some cases, as discussed above, the index assignment algorithm to be employed in the index assignment matrix design may put restrictions on the bandwidth v, and the selection of step 630 could then advantageously take such restrictions into account.

The embodiment of selecting the bandwidth v illustrated in FIGS. 6a and 6b could be performed in a transmitting node 105 and/or receiving node 110 in an on-line fashion. Transmission condition information reflecting the current transmission conditions could then advantageously be received by the transmitting/receiving node from another network node in a communications system 100. Alternatively, selection according to the method of FIGS. 6a and 6b of suitable bandwidths v for different transmission conditions could be performed off-line, and the results of such off-line selection could be made accessible for the transmitting node 105 and/or receiving node 110, stored for example in a table, or in any other suitable storage formats. An example of such results is given in Table 1, wherein the optimal admissible bandwidth v is given for different values of probability of erasure w. The values of the probability of erasure w in such a table could be expressed either as discrete values, or as ranges of values.

TABLE 1
Values of the bandwidth for different probabilities of erasure w.

| | Range of w | | | | |
|---|---|---|---|---|---|
| | 0- | 0.002- | 0.006- | | |
| | 0.002 | 0.006 | 0.012 | 0.012-0.058 | 0.058-1 |
| Optimal admissible v | 7 | 5 | 4 | 3 | 2 |
| Optimal index | linear | linear | Herringbone, even | Herringbone, odd; | staggered |
| assignment algorithm | | | | linear | |

It can be seen that the staggered index assignment algorithm is optimal for a wide range of erasure probabilities.

When transmitting node 105 and/or receiving node 110 have access to pre-selected values of bandwidth v for different transmission conditions, such as those presented in Table 1, step 503 of the method illustrated in FIG. 5 would be performed in the transmitting/receiving node 105/110 by looking up a suitable bandwidth v for given transmission conditions. This is illustrated in FIG. 6c.

Step 503 of FIG. 5 as illustrated in FIG. 6c comprises steps 635-645. In step 635, stored values of transmission conditions with associated suitable bandwidths v are accessed. In step 640, the value of the transmission condition for which a suitable bandwidth is to be selected is compared to the stored values of the transmission conditions. In step 645, the bandwidth v which is associated with the stored transmission condition that has provided the best match in the comparison is selected as a suitable bandwidth v. Different tables/storages could be used for different optimisation scenarios and/or different index assignment algorithms, wherein the different values stored in the tables/storages would have been obtained from different polynomials.

In one implementation of the invention in a communications system 100, a predetermined index assignment algorithm could be used in step 505 for the design of the index assignment matrix 400 (e.g. the linear algorithm, the nested algorithm, etc.). In this implementation, for a particular optimisation scenario, a predetermined polynomial corresponding to the predetermined index assignment algorithm would preferably be used for obtaining a value of v (for example one of the polynomials given by expressions (28)-(39)). The index assignment matrix 400 would then be designed according to the predetermined index assignment algorithm, having a bandwidth v obtained from the predetermined polynomial.

In another implementation of the invention, the index assignment algorithm to be used could depend on the transmission conditions. It turns out that the optimal index assignment algorithm depends on the transmission conditions, and in particular, the optimal index assignment algorithm depends on the value of the bandwidth v. In table 2, the optimal index assignment algorithm is listed for different values of the bandwidth v.

TABLE 2
Optimal index assignment algorithms for
different values of the bandwidth v.

| Bandwidth v | Optimal index assignment algorithm |
|---|---|
| 2 | staggered |
| 3 | linear, nested or herringbone |
| 4 | herringbone or Balogh |
| 5 | linear, nested or herringbone |
| 6 | Balogh |
| 7 | possibly Balogh, but linear, nested |
| | and herringbone nearly as good |
| 8 | Balogh |

In order to obtain a value of the bandwidth v, a predetermined polynomial could be used for the particular optimisation problem of interest, and the optimal index assignment algorithm for the obtained value of the bandwidth v could then be selected in accordance with table 2. Alternatively, various polynomials could be solved, each polynomial relating to an index assignment algorithm and being relevant to the optimisation problem of interest. The index assignment algorithm for which the corresponding polynomial gives the lowest value of v could then be selected as the index assignment algorithm to be used for designing the index assignment matrix 400. If more than one polynomial/index assignment algorithm yield the lowest value of v, the index assignment algorithm that is preferred for the given value of the bandwidth v could advantageously be selected for the design of the index assignment matrix 400 (cf. Table 2).

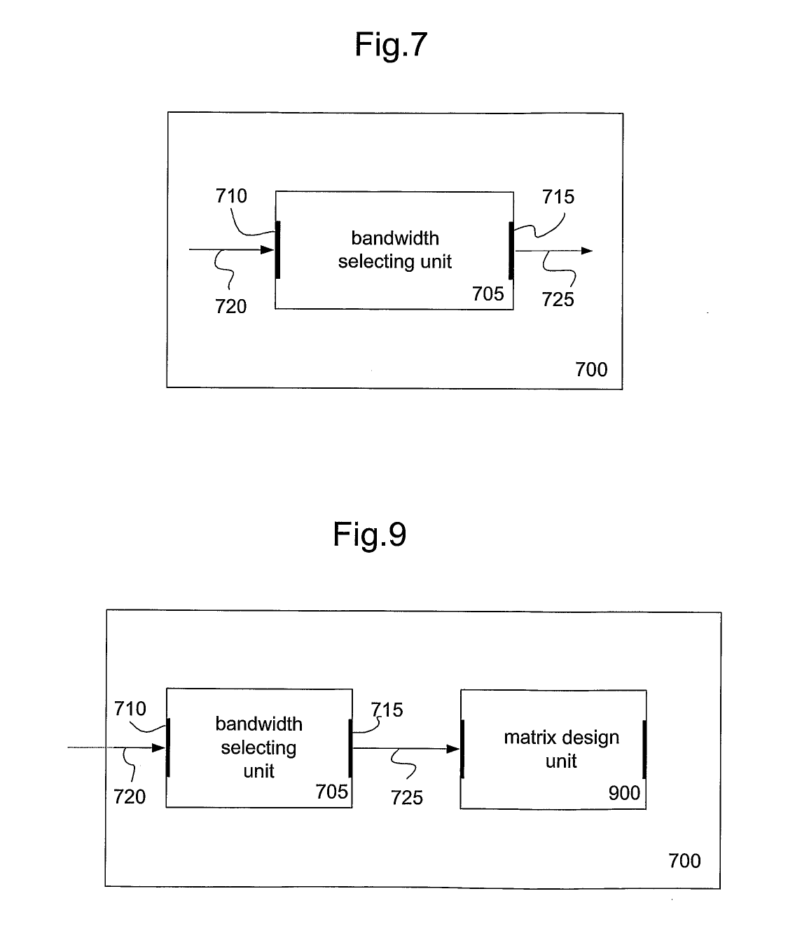

FIG. 7 is a schematic illustration of an apparatus 700 comprising a bandwidth selecting unit 705. The apparatus 700 could for example be an encoder, a decoder, a user equipment comprising an encoder or decoder, a network node comprising an encoder or decoder, or a bandwidth calculation device adapted to calculate the optimal bandwidth v of an index assignment matrix 400 for different transmission conditions.

The bandwidth selecting unit 705 is adapted to select a suitable bandwidth for an index assignment matrix 400 under particular transmission conditions. Bandwidth selecting unit 705 comprises an input 710 adapted to receive a signal 720 indicative of transmission condition information, and an output 715 adapted to output a signal 725 indicative of a suitable bandwidth v.

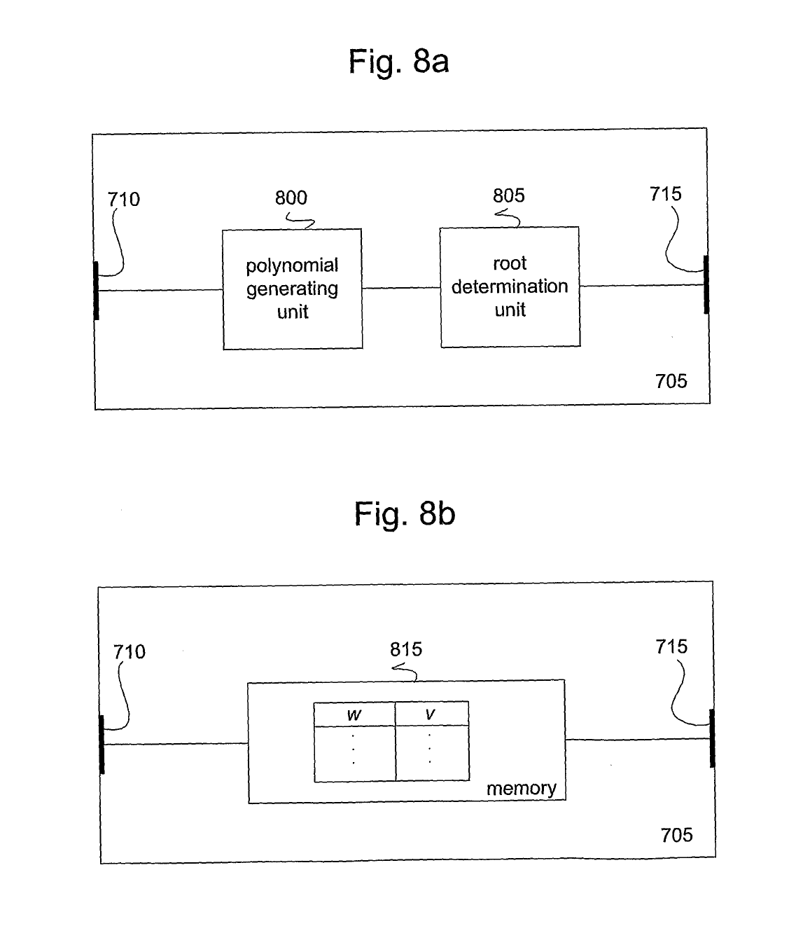

FIG. 8a illustrates an embodiment of the bandwidth selecting unit 705. The bandwidth selecting unit 705 of FIG. 8a comprises a polynomial generating unit 800, a root determination unit 805, and an output signal generating unit 810. The polynomial generating unit 800 is connected to the input 710, and is adapted to receive the signal 720 indicative of transmission condition information. Furthermore, the polynomial generating unit 800 is arranged to generate, based on the received transmission condition information, a polynomial that would be suitable for bandwidth selection. Such polynomial could for example be derived from one of the expressions (28)-(39). In some implementations of the invention according to this embodiment, the polynomial generating unit 800 would be adapted to generate more than polynomial based on the transmission condition information, such as for example more than one polynomial relating to the same optimisation scenario but different index assignment algorithms, or more than one polynomial relating to the same index assignment algorithms, but different optimisation scenarios, or any set of polynomials. The polynomial generating unit 800 is furthermore preferably adapted to output a signal indicative of the polynomial(s) generated by the polynomial generating unit 800.

The output of the polynomial generating unit 800 is preferably connected to the root determination unit 805, which is adapted to determine a feasible root of the polynomial generated by the polynomial generating unit 800 (a feasible root is in this context a root which is real and larger than zero). The root determination unit 805 is connected to the output 715 of the bandwidth selecting unit 705. In one aspect of this embodiment of the invention, the root determination unit 805 generates a signal indicative of the actual value of the feasible root. A value of the bandwidth v could then be selected elsewhere, based on the value of the root, either by another component of the bandwidth selecting unit 705, or in another device used for the design of an index assignment matrix. In the latter case, the signal 725 output from the bandwidth selecting unit 705 would not explicitly indicate a selected bandwidth v, but rather indicate such selected bandwidth v in an implicit manner by indicating the value of a root from which a suitable bandwidth v may be derived. In another aspect of this embodiment, the root determination unit 805 generates a signal indicative of a rounded or truncated value of the root, corresponding to a bandwidth v.

When the polynomial generating unit 800 is arranged to generate more than one polynomial for a particular value of the transmission conditions, the output signal 725 could be arranged to indicate a value of the bandwidth v for each of these polynomials. Alternatively, the output signal 725 could be arranged to indicate the most favourable value of the bandwidth v, preferably together with an indication of which polynomial gave rise to this value.

FIG. 8b illustrates an alternative embodiment of the bandwidth selecting unit 705, wherein the bandwidth selecting unit 705 has access to a data storage medium 815, referred to as memory 815, in which different values of transmission conditions are stored together with associated values of the bandwidth v. Memory 815 could be any type of data storage medium. In FIG. 8b, the memory 815 is shown to be a part of bandwidth selecting unit 705. Alternatively, memory 815 could be a memory external to bandwidth selecting unit 705, and to which bandwidth selecting unit 705 has access. In this embodiment, bandwidth selecting unit 705 is arranged to compare the transmission condition information received in the signal 720 to the different values of the transmission condition stored in the memory 815, and to select as the bandwidth v the value of the bandwidth v which in memory 815 is associated with the stored value of the transmission condition that best matches the received transmission condition information.

FIG. 9 schematically illustrates an embodiment of an apparatus 700 comprising a matrix design unit 900 as well as a bandwidth selecting unit 705. The output 715 of the bandwidth selecting unit 705 is connected to an input of the matrix design unit 900. The matrix design unit 900 is adapted to design an index assignment matrix 400 in dependence of the signal 725 indicating a suitable bandwidth v of the index assignment matrix 400. The output of the matrix design unit 900 is used to determine the mapping functions α₁(k) and α₂(k), and/or the mapping functions β₀(k₁,k₂), β₁(k₁) and β₂(k₂) of the side coders 210 and decoders 225/230 of FIG. 2. The apparatus 700 of FIG. 9 could for example be part of a control unit of an encoder 125 or a decoder 130.

The configuration of FIG. 9 is particularity suitable for applications of the invention where the bandwidth v of the index assignment matrix 400 used for multiple encoding of an information signal x is adapted to current transmission conditions. In such applications, the signal 720 indicative of transmission condition information could advantageously originate from a node in the communications system 100 having knowledge of the current transmission conditions in the communications system 100, such as for example an Operations & Maintenance node; the receiving node 110 in case the bandwidth selecting unit 705 is part of the transmitting node 105; a radio base station when the bandwidth selecting unit 705 is part of a user equipment for mobile communications; etc. More explicit examples follows: the probability of erasure w can be estimated at the receiving node 110 and communicated to the transmitting node 1105; the probability of erasure w can be estimated at a network node and communicated to the transmitting node 105; the information about available hit rate can be determined by the transmitting node 105 or communicated to the transmitting node 105 from a network node; a user or a receiving node 110 that receives the descriptions may request the transmitting node 105 that the central and side coder distortions be adjusted, etc.

In applications of the invention wherein the design of an index assignment matrix 400 will be performed at a later time than the selection of a bandwidth v, the input signal 720, indicative of transmission condition information, could for example originate from a process internal to the apparatus 700 of which the bandwidth selection unit 705 forms a part, from values that have been entered manually, from stored values, or from nodes having knowledge of the current and/or previous transmission conditions.

If only one of the transmitting node 105 and the receiving node 110 is arranged to receive the transmission condition information, a signal indicative of the transmitting condition information, and/or indicative of the optimal value of the bandwidth v that has been selected in response to the transmission condition information, should preferably be transmitted to the other of the transmitting node 105 and the receiving node 110. In this way, it can be ensured that the encoder 125 and the decoder 130 both operate according to the same index assignment matrix 400 and hence according to the same mapping of the central quantizer indices k onto the side coder indices Mⱼ.

The bandwidth selecting unit 705, as well as the matrix design unit 900, can advantageously be implemented by suitable computer software and/or hardware.

Although the invention has mainly been described above in terms of a square assignment matrix 400, where j=2 and M₁=M₂ the invention is equally applicable for encoding of an information signal x by means of an index assignment matrix wherein Mⱼ_{ᵢ}≠Mⱼ_{ⱼ}, for all values of j. Some of the expressions provided above by way of example will then have to be amended accordingly. For example, the average pattern of indices h(v) would depend on j: h(v)=h^{(j)}(v), and should therefore preferably be considered separately for each side-coder cell that would exist in the system. Furthermore, a cost function (cf. expression (4)) should preferably be adjusted to correctly reflect the possible distortions that contribute to the composite distortion dᵢ.

Similarly, in the above description, the invention has mainly been described in terms of two-dimensional encoding, where the central quantizer indices k are mapped onto two different side coder cells αⱼ⁻¹(i). However, the invention works equally well for multiple description coding using more than two descriptions. Some of the expressions provided above will have to be amended accordingly. For example, the bandwidth of the index assignment matrix would typically be described by a bandwidth vector v, and an analytical function corresponding to expression (16) could be derived for each transmission channel 120^{(j)}. However, in the symmetrical case, where the same rates R and same probability of erasure w apply to all transmission channels 120^{(j)}, it would still be possible to reduce the optimisation problem to finding a scalar value of the bandwidth v.

In the above, the invention has been described in relation to the encoding/decoding of a scalar source x for purposes of illustration. However, the invention may also be applied to the encoding/decoding of a vector source, x.

In the derivation of the analytical expressions for the central distortion d₀ as well as the side coder distortion dⱼ above, a high rate of the encoding has been assumed. However, the rate does not have to be particularly high for the high rate assumption to be justified in the derivations above: For example, applying the high rate assumption yields good results if (in a resolution constrained case) each side coder cell index kⱼ is represented by 3 bits, resulting in a maximum size of the index assignment matrix 400 of 8*8 entries. Typically, the size of the index assignment matrix 400 is greater than 8*8—for example 128*1.28, or 256*256 entries.

Multiple description coding according to the invention can advantageously be used for transmission of audio and/or visual information such as speech or video over packet-switched networks where the probability of packet loss is non-zero, as well as for transmission of signals in scenarios wherein signal fading may be a problem, such as for example for the transmission of radio signals over a radio interface.

### APPENDIX 1

### Approximation of the Pattern of Indices in the Index Assignment Matrix

In the following, an average pattern of indices h(v) will be derived for the nested index assignment algorithm. The nested index assignment algorithm is used as an illustrative example only, and average patterns of indices h(v) can be derived for any index assignment algorithm.

An aim is to approximate the pattern produced by the nested index assignment in order to get a reliable estimate of geometry of an “average” side quantizer cell. The approximation is needed to estimate an optimal position of a reconstruction point within the side coder cell, to be used when determining the side coder distortion. There are many possible approximations that will result in a formula that describes the pattern of indices with enough accuracy to get a reasonable estimate of the side coder cell geometry in order to get an estimate of where the reconstruction points of the side coders are, and hence, a reasonable estimate of the side quantizer distortion.

The normalised pattern of indices may be seen as a sequence of integers obtained by considering a particular row (or column) of the index assignment matrix and subtracting the smallest element within the row from the other elements.

In order to get an approximation of the average pattern of indices h(v) we make the following assumptions:
1) the patterns in the index assignment matrix 400 appear periodically and the number of possible patterns is finite, so it makes sense to consider an average or typical pattern;
2) here, a symmetrical case is considered so it is assumed that the pattern is the same along the rows and columns. An extension to the non-symmetrical case is straightforward. In a non-symmetrical, two-channel case an approximation could advantageously be made separately for all the rows and the columns of the index assignment matrix.
3) the pattern can be averaged and expressed in terms of a parameter that describes a band of the index assignment matrix 400.

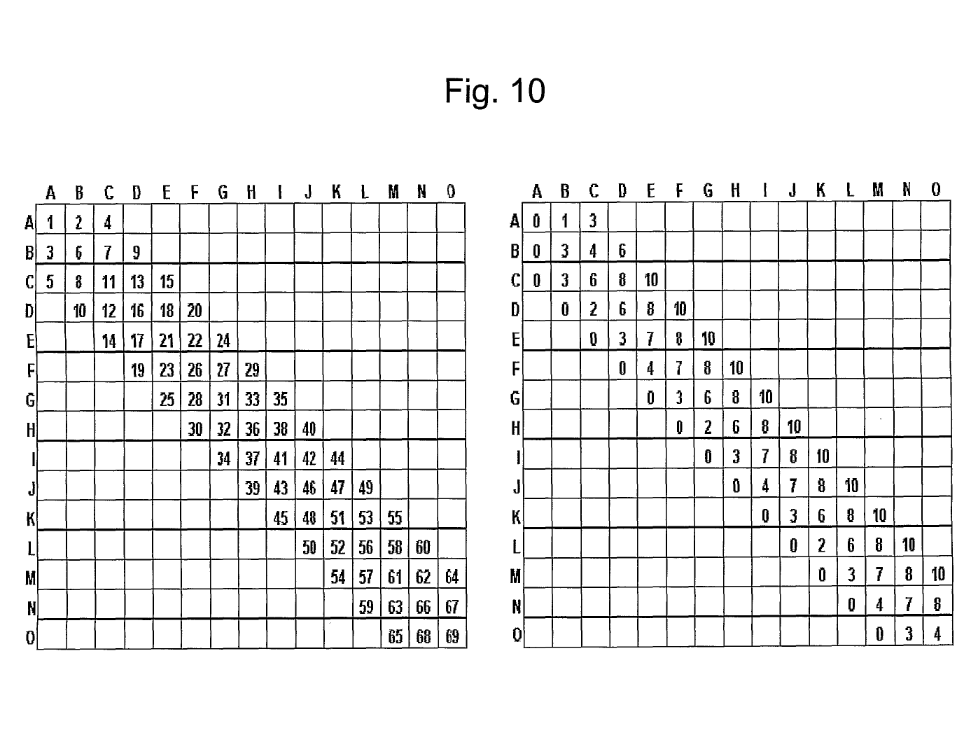

An example of an Index assignment matrix (left) for nested index assignment and corresponding side cell patterns (right) is provided in FIG. 10.

An index assignment matrix 400 for the nested index assignment with 5 diagonals is shown in the left part of FIG. 1. The corresponding side coder cell patterns are shown at the right side of the figure. We can see that the pattern varies across the index assignment matrix, but the pattern is almost the same as we go from one side cell to another. We will now consider the side coder whose cells are represented by the rows in the index assignment matrix. Note that in the next step we neglect the boundary effect in the corners of the matrix. For v=5, the following patterns appear {0, 2, 6, 8, 10}, {0, 3, 7, 8, 10}, {0, 4, 7, 8, 10}, {0, 3, 6, 8, 10}. The sequence of patterns appears periodically. Furthermore, the consecutive patterns do not vary much and the weight centre of these patterns is approximately at the same place. We can then average these patterns to obtain: {0, 3, 6, 8, 10}. The average pattern should contain only integer elements. If an element of the average pattern is non-integer, this element should preferably be rounded or truncated.

Now we want to express such pattern in terms of the bandwidth v of the index assignment matrix 400.

We can find such average patterns for different values of v. For instance, in case of the nested index assignment, we have the following patterns:
a) v=3; {0, 1, 3}
b) v=5; {0, 3, 6, 8, 10}
c) v=7; {0, 5, 10, 15, 17, 19, 21}
d) v=9; {0, 7, 14, 21, 28, 30, 32, 34, 36}
e) v=11; {0, 9, 18, 27, 36, 45, 47, 49, 51, 53, 55}

By observation of the pattern we can express the pattern of indices in terms of v. We obtain a universal formula that describes this average pattern, referred to as the average pattern of indices, h(v):

h(v)={(k−1)(2z−1),k=1, . . . , z+1}∪{z(2z−1)+2(k−z−1):k=z+2, . . . , 2z+1);

where

$$z = \frac{1}{2} ( v - 1 ) .$$

Note that the pattern has been expressed as a set of elements which depends only on v.

### APPENDIX 2

### Various optimization scenarios

### (Two-Dimensional Symmetrical Case)

We use the following definitions of the distortions:
1) composite distortion (two-dimensional, symmetrical case)

dₜ=(1−w)²d₀+2w(1−w)d_{S}
2) central distortion d₀
3) side distortion d_{S}

We use the following expression to represent the entropy constraint for the side quantizers:

For a continuous source with known pdf p(x) we are able to find differential entropy

$$h ( X ) = - {\int }_{- ∞}^{∞} p ( x ) {log}_{2} p ( x ) d x .$$

By using definition of the entropy

$$H = - {\sum }_{{k}_{j} = 1}^{{M}_{j}} P ( {k}_{j} ) {log}_{2} [ P ( {k}_{j} ) ] ,$$

where P(kⱼ) is a probability of side quantization index kⱼ (where j specifies the side coder), we can express the entropy constraint as:

$$H = - {\sum }_{i = 1}^{M} P ( i ) {log}_{2} [ P ( i ) ] = h ( X ) - E \{ {log}_{2} [ Δ ( x , v ) ] \} - {log}_{2} ( v ) \qquad ( A2 \text{:} 1 )$$

We use the following formulation to represent the resolution constraint:

In a symmetrical case each side quantizer has precisely M reconstruction points. Let the rate that is used to communicate a single side quantization index is R. It means that M=2^{R}

Below we Consider Different Optimization Scenarios

### A) Minimization of Composite Distortion Subject to Entropy Constraint

Formally the problem may be written as

mind dₜ

subject to H=R (A2:2)
where the minimization is performed over the
The optimization problem can be written using the following Lagrangian:

$$\frac{{( 1 - w )}^{2}}{12} {\int }_{{t}_{1}}^{{t}_{r + 1}} p ( x ) {Δ ( x , v )}^{2} d x + 2 \frac{( 1 - w ) w}{v} f ( v ) {\int }_{{t}_{1}}^{{t}_{r + 1}} p ( x ) {Δ ( x , v )}^{2} d x + … \\ λ ( h ( X ) - E \{ log [ Δ ( x , v ) ] \} - log ( v ) - R ) \qquad ( A2 \text{:} 3 )$$

The Euler-Lagrange equation for the following cost function is

$$\frac{{( 1 - w )}^{2}}{6} Δ ( x , v ) + 4 \frac{( 1 - w ) w}{v} f ( v ) Δ ( x , v ) - \frac{λ}{Δ ( x , v )} = 0 , \qquad ( A2 \text{:} 4 )$$

We can see that Δ(x,v) does not depend on x.
Solving the equation for nested, linear and herringbone index assignment we obtain:

$$Δ ( v ) = \frac{1}{v} {2}^{h ( X ) - R} , \qquad ( A2 \text{:} 5 )$$

and for staggered index assignment:

Δ=2^{h(X)-R-1}. (A2:6)
Using these Results, the Composite Distortion May be Written as

$$D ( v , w ) = g \frac{{( 1 - w )}^{2}}{12 {v}^{2}} + g \frac{2 ( 1 - w ) w}{{v}^{3}} f ( v ) , \\ g = {2}^{2 ( h ( X ) - R )} , \\ v \geq 1 \qquad ( A2 \text{:} 7 )$$

It can be optimized for v by differentiating it with respect to v

$$\frac{d}{d v} D ( v , w ) = \frac{2 g ( 1 - w ) w}{{v}^{3}} {f}^{′} ( v ) - \frac{6 g ( 1 - w )}{{v}^{4}} f ( v ) - \frac{{g ( 1 - w )}^{2}}{6 {v}^{3}} , \\ v \geq 1. \qquad ( A2 \text{:} 8 )$$

After some algebra, we get the univariate polynomials (28)-(31) of the detailed description.

### B) Minimization of the Composite Distortion Subject to Constraint on Side Coder Resolution

The design problem can be formulated as follows:

$$min {d}_{t} ( v , w ) \\ subject to \\ {\int }_{{t}_{1}}^{{t}_{r + 1}} \frac{1}{Δ ( x , v )} d x = {2}^{Rv} = Mv \qquad ( A2 \text{:} 9 )$$

This design problem corresponds to the following Lagrangian formulation:

$$\frac{{( 1 - w )}^{2}}{12} {\int }_{{t}_{1}}^{{t}_{r + 1}} p ( x ) {Δ ( x , v )}^{2} d x + 2 ( 1 - w ) w \frac{f ( v )}{v} {\int }_{{t}_{1}}^{{t}_{r + 1}} p ( x ) {Δ ( x , v )}^{2} d x + … + λ ( {\int }_{{t}_{1}}^{{t}_{r + 1}} \frac{1}{Δ ( x , v )} d x - Mv ) . \qquad ( A2 \text{:} 10 )$$

This results in the Euler-Lagrange equation:

$$\frac{{( 1 - w )}^{2}}{6} Δ ( x , v ) p ( x ) + 4 ( 1 - w ) w \frac{f ( v )}{v} Δ ( x , v ) p ( x ) - \frac{λ}{v {Δ ( x , v )}^{2}} = 0 \qquad ( A2 \text{:} 11 )$$

Solving for Δ(x,v) gives the following result:

$$Δ ( x , v ) = \frac{1}{Mv} \frac{{\int }_{{t}_{1}}^{{t}_{r + 1}} {( p ( x ) )}^{\frac{1}{3}} d x}{{( p ( x ) )}^{\frac{1}{3}}} . \qquad ( A2 \text{:} 12 )$$

The central coder distortion can be expressed by:

$${d}_{0} = \frac{1}{12 {M}^{2} {v}^{2}} {( {\int }_{{t}_{1}}^{{t}_{r + 1}} {( p ( x ) )}^{\frac{1}{3}} d x )}^{3} \qquad ( A 2 \text{:} 13 )$$

and the expression for the side coder distortion is then

$${d}_{j} = \frac{f ( v )}{{M}^{2} {v}^{3}} {( {\int }_{{t}_{1}}^{{t}_{r + 1}} {( p ( x ) )}^{\frac{1}{3}} d x )}^{3} , \\ j = 1 , 2. \qquad ( A2 \text{:} 14 )$$

It is possible to derive the optimal bandwidth v for all considered index assignment algorithms. We make use of the following equation:

$$\begin{matrix}{d}_{T} = \frac{{( 1 - w )}^{2} ξ}{12 {v}^{2}} + \frac{2 ( 1 - w ) wf ( v ) ξ}{{v}^{3}} , \\ wherein & ( A2 \text{:} 15 ) \\ ξ = \frac{1}{{M}^{2}} {( {\int }_{{t}_{1}}^{{t}_{r + 1}} {( p ( x ) )}^{\frac{1}{3}} d x )}^{3} , & ( A 2 \text{:} 16 )\end{matrix}$$

(A2:15) has the same structure as equation (A2:7). Thus, the polynomials for computing an optimal bandwidth v for the constrained resolution case are the same as those for the entropy constrained case, which are given by expressions (28)-(31) of the detailed description.

### C) Minimization of Central Distortion Subject to the Constraint on the Side Coder Distortion and Side Coder Entropy

This design problem may be expressed as:

min d₀

subject to

dⱼ<dₛ, j=1,2

H=R (A2:17)
where dₛ is a maximum acceptable side coder distortion.
We recall that an index assignment is characterized by a function ƒ(v) which is a positive, monotonically increasing function. Given ƒ(v), the side distortion dⱼ (equally for both side coders) is given by expression (17) of the detailed description, and the central distortion d₀ is given by expression (6) of the detailed description. Using the fore-mentioned expressions we can construct the Euler-Lagrange equation for the problem considered. This Euler-Lagrange equation is:

$$\frac{1}{6} Δ ( x , v ) + 4 {λ}_{1} \frac{f ( v )}{v} Δ ( x , v ) - {λ}_{2} \frac{1}{Δ ( x , v )} = 0 , \qquad ( A2 \text{:} 18 )$$

and it tells us, as in the optimization scenario A), that

Δ(x,v)=Δ(v)=const. (A2:19)
Substituting the above result into the rate constraint equations we get

$$Δ ( v ) = \frac{1}{v} {2}^{h ( X ) - R} . \qquad ( A2 \text{:} 20 )$$

The above result allows us to resolve the side distortion constraint. The side distortion constraint leads to

dₛv³−ƒ(v)2²⁽h(X)−R)≧0 (A2:21)
The last equation depends on the function ƒ(v). Changing inequality into equality we obtain a function of v that can be optimized for v resulting in a polynomial. Polynomials obtained from (A2:21) for a number of different index assignment algorithms are given by expressions (32)-(35) of the detailed description.

### D) Minimization of Central Distortion Subject to the Constraint on the Side Distortion and Side Quantizer Resolution

This design problem can be expressed as:

$$\begin{matrix}min {d}_{0} , \\ subject to {d}_{j} < {d}_{s} , j = 1 , 2 & ( A2 \text{:} 22 ) \\ {\int }_{{t}_{1}}^{{t}_{r + 1}} \frac{1}{Δ ( x , y )} d x = {2}^{R} v = Mv & ( A2 \text{:} 23 )\end{matrix}$$

The extended criterion to be optimized is thus

$$\frac{1}{12} {\int }_{{t}_{1}}^{{t}_{r + 1}} p ( x ) {Δ ( x , v )}^{2} d x + {λ}_{1} ( \frac{f ( v )}{v} {\int }_{{t}_{1}}^{{t}_{r + 1}} p ( x ) {Δ ( x , v )}^{2} d x - {d}_{s} ) + {λ}_{2} ( {\int }_{{t}_{1}}^{{t}_{r + 1}} \frac{1}{v Δ ( x , v )} d x - M ) . \qquad ( A2 \text{:} 24 )$$

The corresponding Euler-Lagrange equation is:

$$\frac{1}{6} p ( x ) Δ ( x , v ) + 2 {λ}_{1} \frac{f ( v )}{v} p ( x ) Δ ( x , y ) - {λ}_{2} \frac{1}{v {Δ ( x , v )}^{2}} = 0. \qquad ( A2 \text{:} 25 )$$

The optimization problem can be solved yielding:

$$\begin{matrix}{d}_{s} {M}^{2} {v}^{3} - f ( v ) β \geq 0 , \\ where & ( A2 \text{:} 26 ) \\ β = {( {\int }_{{t}_{1}}^{{t}_{r + 1}} ( {p ( x )}^{\frac{1}{3}} ) d x )}^{3} & ( A2 \text{:} 27 )\end{matrix}$$

(A2:26) depends on the function ƒ(v). Changing inequality into equality, we obtain a function of v that can be optimized for v resulting in a polynomial. The resulting polynomials for a number of different index assignment algorithms are given by expressions (36)-(39) of the detailed description.

In the optimisation scenarios discussed above, the minimisation of the distortion expressed by expressions (A2:2), (A2:9), (A2:17) and (A2:22) should be performed over the set of all mapping functions (α₀,α₁,α₂,β₀ . . . ) relevant to the optimisation scenario.

1. A method for designing an index assignment matrix for use in multiple description coding of an information signal, the method comprising:
selecting a bandwidth for the index assignment matrix in dependence of transmission condition information relating to a transmission condition of a communication channel onto which a description of the information signal can be transmitted, wherein
the selecting of a bandwidth is performed in dependence of a root of a polynomial of which a real and positive root can be rounded or truncated to correspond to a value of the bandwidth, and wherein the coefficients of the polynomial are determined in dependence of the transmission condition information.

2. The method of claim 1, wherein the index assignment matrix is a two-dimensional, square matrix in and wherein said polynomial is:
5wv⁶−4wv⁵+8wv³−(37w+8)v²−36wv+96w
for a nested index assignment;
2wv⁶−(5w+4)v²+3w
for a linear index assignment;
5wv⁴−2wv³−8wv+8w−8
for a herringbone index assignment of even v;
5wv⁵−2wv⁴−20wv²+(35w−8)v−18w
for a herringbone index assignment of odd v; and
wherein v is the bandwidth of the index assignment matrix and w is the probability of erasure on a communications channel over which descriptions of the information signal obtained by means of the index assignment matrix are to be transmitted.

3. The method of claim 1, wherein
the polynomial has been derived from an analytic estimation of side coder distortions obtained under the following assumptions:
the pattern of indices in a side coder cell of the index assignment matrix can be approximated as constant for purposes of estimating the side coder distortion; and
the extent of a central quantizer cell is assumed to be constant within the extent of a side coder cell.

4. The method of claim 3, wherein the index assignment matrix is two-dimensional, square matrix and the polynomial has been derived using the following expression:
$$f ( v ) = {\sum }_{k ∈ h ( v )} ( \frac{1}{3} + k + {k}^{2} ) - \frac{1}{4 v} {( {\sum }_{k ∈ h ( v )} ( 1 + 2 k ) )}^{2} ,$$
wherein v is the bandwidth;
$$\frac{f ( v )}{v}$$
is a coefficient of quantization; k is an index of a central quantizer cell; and h (v) is the normalized pattern of indices of a side coder cell.

5. The method of claim of claim 1, wherein the selecting comprises the following steps:
accessing a memory storing information corresponding to a table over possible values of a transmission condition and corresponding suitable bandwidth values;
comparing the transmission condition information for which a bandwidth is to be selected to the possible values of the transmission condition stored in the memory; and
selecting the bandwidth in accordance with the information stored in the memory.

6. The method of claim 1, further comprising
designing the index assignment matrix by way of an index assignment algorithm in a manner so that the index assignment matrix has the selected bandwidth.

7. The method of claim 6, further comprising
selecting the index assignment algorithm in dependence of the selected bandwidth.

8. The method of claim 1, wherein
the transmission condition information is received from a node in a communications network as at least one signal indicative of transmission conditions.

9. A method of encoding an information signal according to multiple description coding, the method comprising:
applying an index assignment matrix to a representation of the information signal in order to obtain at least two different descriptions of the information signal, wherein the index assignment matrix has been designed by selecting a bandwidth for the index assignment matrix in dependence of transmission condition information relating to a transmission condition of a communication channel onto which a description of the information signal can be transmitted, wherein the selecting of a bandwidth is performed in dependence of a root of a polynomial of which a real and positive root can be rounded or truncated to correspond to a value of the bandwidth, and wherein the coefficients of the polynomial are determined in dependence of the transmission condition information.

10. A method of decoding an information signal which has been encoded according to multiple description coding, the method comprising:
receiving at least one description of the information signal; and
mapping the at least one description on an index assignment matrix to obtain a reconstruction value of the information signal; and
wherein the index assignment matrix has been designed by selecting a bandwidth for the index assignment matrix in dependence of transmission condition information relating to a transmission condition of a communication channel onto which a description of the information signal can be transmitted, wherein the selecting of a bandwidth is performed in dependence of a root of a polynomial of which a real and positive root can be rounded or truncated to correspond to a value of the bandwidth, and wherein the coefficients of the polynomial are determined in dependence of the transmission condition information.

11. An apparatus for use in the design of an index assignment matrix to be used in multiple description coding of an information signal, the apparatus comprising:
a bandwidth selecting unit adapted to generate a signal indicative of a bandwidth of the index assignment matrix; wherein
the bandwidth selecting unit has an input adapted to receive transmission condition information indicative of a transmission condition on a communication channel onto which a description of the information signal can be transmitted;
the bandwidth selecting unit is adapted to generate the signal indicative of the bandwidth in dependence of a root of a polynomial of which a real and positive root can be rounded or truncated to correspond to a value of the bandwidth, and wherein the coefficients of the polynomial are determined in dependence of the transmission condition information; and
the bandwidth selecting unit has an output adapted to output the signal indicative of the bandwidth.

12. The apparatus of claim 11, wherein the bandwidth selecting unit is configured to:
generate a polynomial wherein the coefficients of the polynomial are determined in dependence of the transmission condition information;
determine a root of the polynomial; and wherein
the output is adapted to generate the output signal in dependence of the root of the polynomial.

13. The apparatus of claim 11, wherein the bandwidth selecting unit is adapted to:
access a memory storing information corresponding to a table over possible values of a transmission condition and corresponding suitable bandwidth values;
compare the received transmission condition information to the possible values of the transmission condition stored in the memory; and
select the bandwidth in accordance with the information stored in the memory.

14. The apparatus of claim 11, wherein the apparatus is configured to
design an index assignment matrix by way of an index assignment algorithm in a manner so that the index assignment matrix has the selected bandwidth.

15. The apparatus of claim 14, further adapted to:
select the index assignment algorithm in dependence of the bandwidth.

16. The apparatus of claim 11, wherein
the output is further adapted to output a signal indicative of the transmission condition for which the bandwidth has been selected.

17. The apparatus of claim 11, wherein the apparatus is an encoding device or a decoding device.

18. (canceled)

19. The apparatus of claim 17, wherein the apparatus comprises part of a user equipment.

20. The apparatus of claim 17, wherein the apparatus comprises part of a network node.

21. The apparatus of claim 13, wherein the input is adapted to receive the transmission condition information from a node in a communications system.

22. (canceled)

23. A computer program product for use in the design of an index assignment matrix to be used in multiple description coding of an information signal, the computer program product comprising computer program instructions stored in a computer-readable medium, said computer program instructions comprising:
computer program code portions adapted to, when run on a computer, select a bandwidth for the index assignment matrix in dependence of a root of a polynomial of which a real and positive root can be rounded or truncated to correspond to a value of the bandwidth, and wherein the coefficients of the polynomial are determined in dependence of transmission condition information relating to a transmission condition of a communication channel onto which a description of the information signal can be transmitted.
